(19) United States
(12) Patent Application Publication
(10) Pub. No.: US 2024/0283195 A1
(43) Pub. Date: Aug. 22, 2024

(54) ELECTRICAL CONNECTOR FOR SYSTEM WITH TALL CARD

(71) Applicant: Amphenol Commercial Products (Chengdu) Co., Ltd., Chengdu (CN)

(72) Inventors: Kui Yang, Chengdu (CN); Xiaodong Hu, Chengdu (CN)

(73) Assignee: Amphenol Commercial Products (Chengdu) Co., Ltd., Chengdu (CN)

(21) Appl. No.: 18/583,101

(22) Filed: Feb. 21, 2024

(30) Foreign Application Priority Data
Feb. 22, 2023 (CN) 202310153540.2
Feb. 22, 2023 (CN) 202320291655.3

(51) Int. Cl. H01R 13/627; H01R 12/71; H01R 13/502; H01R 13/639

(52) U.S. Cl. CPC H01R 13/6273; H01R 12/71; H01R 13/502; H01R 13/639

(57) ABSTRACT

A connector for economic and reliable operation of systems, such as systems having tall cards. The connector has a housing body, a tower extending from an end of the housing body and beyond a position that a notch of a standard card would be in a height direction, and a latch configured to cooperate with tall cards. The tower can have a first portion extending from the end of the housing body and a second portion coupled to the first portion. The latch can have a first member pivotable about an end of a second member so as to move the second member up and down when the latch moves between a locked position and an unlocked position. Such a configuration enables the connector to provide reliable connections for tall cards, while compatible with physical requirements of industry standards, for example, in length/width directions.

### CROSS-REFERENCE TO RELATED APPLICATIONS

This application claims priority to and the benefit of Chinese Patent Application Serial No. 202320291655.3, filed on Feb. 22, 2023. This application also claims priority to and the benefit of Chinese Patent Application Serial No. 202310153540.2, filed on Feb. 22, 2023. The contents of these applications are incorporated herein by reference in their entirety.

### TECHNICAL FIELD

This application relates generally to electrical interconnection systems, such as those including electrical connectors, used to interconnect electronic assemblies.

### BACKGROUND

Electrical connectors are used in many electronic systems. It is easier and more cost effective to manufacture a system as separate electronic assemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

Computers, for example, are often manufactured with connectors that serve as sockets for memory cards. A memory card may contain one or multiple memory chips and may be inserted into a socket to increase the available memory in the computer. Memory cards have standardized electrical and mechanical interfaces, so as do the memory sockets. Many memory cards, for example, are designed according to a DDR standard, such as DDR4 or DDR5.

### BRIEF SUMMARY

Aspects of the present disclosure relate to electrical connectors for economic and reliable operation of systems, such as systems having tall cards.

Some embodiments relate to an electrical connector. The electrical connector may include a housing comprising a body and a first tower portion disposed at an end of the body, the body having a slot, the first tower portion extending beyond a mating face; a second tower portion comprising a first end engaging the first tower portion of the housing and a second end opposite the first end; and a latch coupled to the second tower portion and movable between a locked position and an unlocked position.

Optionally, the second tower portion is made of a material stronger than the housing.

Optionally, the first end of the second tower portion at least partially wraps three surfaces of the first tower portion.

Optionally, the first tower portion comprises a protrusion; and the second tower portion comprise a groove receiving the protrusion of the first tower portion.

Optionally, the electrical connector may further include a member engaging both the first tower portion and the first end of the second tower portion so as to connect the first tower portion with the second tower portion.

Optionally, the member comprises a body, a first engagement portion engaging the first tower portion, and a second engagement portion engaging the first end of the second tower portion.

Optionally, the latch comprises a first member comprising a first surface butting against the second end of the second tower portion when the latch is in the locked position, and a second surface butting against the second end of the second tower portion when the latch is in the unlocked position.

Optionally, the second tower portion comprises a channel extending from the first end to the second end; the latch comprises a second member disposed in the channel and having a first end coupled to the first member such that the first member is pivotably mounted about an end of the second member; and a distance from the end of the second member to the first surface of the first member is less than a distance from the end of the second member to the second surface of the first member.

Optionally, the second member of the latch comprises a second end opposite the first end and extending toward the slot of the housing.

Some embodiments relate to an electrical connector. The electrical connector may include a housing body comprising a mating face, a mounting face, and a slot extending through the mating face and elongating in a longitudinal direction; a plurality of conductive elements held by the housing body, each of the plurality of conductive elements comprising a mating portion curving into the slot and a mounting tail opposite the mating portion and extending out of the mounting face; and a tower extending from an end of the housing body in a vertical direction perpendicular to the longitudinal direction, wherein the tower extends beyond a position that a notch of a standard DDR card would be in the vertical direction.

Optionally, the standard DDR card has a height of 32 mm in the vertical direction; and the notch of the standard DDR card recesses from an edge of the standard DDR card that extends in the vertical direction.

Some embodiments relate to an electrical connector. The electrical connector may include a housing comprising a body and a tower extending from an end of the body, the body having a mating face, a mounting face opposite the mating face, and a slot extending from the mating face toward the mounting face; a plurality of conductive elements held by the housing, each of the plurality of conductive elements comprising a mating portion curving into the slot and a mounting tail opposite the mating portion and extending out of the mounting face; and a latch coupled to the housing and comprising a first member and a second member, wherein the first member is pivotable about an end of the second member so as to move the second member in a vertical direction when the latch moves between a locked position and an unlocked position.

Optionally, the first member of the latch comprises a first surface spaced from the end of the second member by a first distance and a second surface spaced from the end of the second member by a second distance; and the second member moves by a difference between the second distance and the first distance when the latch switches between the locked position and the unlocked position.

Optionally, the first member of the latch comprises a transition surface joining the first surface and the second surface.

Optionally, the first surface and the second surface are perpendicular to each other.

Optionally, when the latch in the locked position, the first surface of the first member abuts against the tower of the housing; and when the latch is in the unlocked position, the second surface abuts against the tower of the housing.

Optionally, the first member of the latch comprises a cavity; the end of the second member of the latch extends into the cavity; and when the latch in the locked position, the second member of the latch abuts against a sidewall of the cavity.

Optionally, the electrical connector may further include a resilient member disposed between the second member of the latch and the tower of the housing, wherein the resilient member deforms a first amount when the latch is in the locked position and a second amount greater than the first amount when the latch is in the unlocked position.

Optionally, the tower of the housing comprises a first tower power extending from the body of the housing and a second tower portion coupled to the first tower power; the first member of the latch is disposed on the second tower portion; and the second member of the latch extends in the second tower portion.

Optionally, the slot of the body of the housing elongates in a longitudinal direction; and the tower extends above a notch of a standard DDR card in a vertical direction perpendicular to the longitudinal direction.

Some embodiments relate to a method of operating an electrical connector comprising a housing body comprising a mating face, a mounting face and a slot extending through the mating face and elongating in a longitudinal direction, a tower extending from an end of the housing body in a vertical direction perpendicular to the longitudinal direction, and a latch coupled to the tower and comprising first and second members. The method may include pivoting the first member of the latch about an end of the second member of the latch so as to move the second member in the vertical direction.

Optionally, the method may include inserting a card into the slot which moves the second member in a direction opposite to the vertical direction.

Some embodiments relate to an electrical connector. The electrical connector may comprise a housing having a body elongating in a longitudinal direction and a first tower power disposed at an end of the body. The body may have a mating face provided with a slot recessed in a vertical direction perpendicular to the longitudinal direction. The first tower portion may protrude beyond the mating face in the vertical direction. The electrical connector may comprise a second tower portion and a latch. The second tower portion may have an engagement end and a latch end opposite each other in the vertical direction. The engagement end may be engaged to the first tower portion. A first member of the latch may be movably disposed at the latch end of the second tower portion between a locked position and an unlocked position.

Optionally, the engagement end of the second tower portion may at least partially wrap three surfaces of the first tower portion.

Optionally, the first tower portion may include an end surface facing the second tower portion in the vertical direction, and a first side surface and a second side surface opposite each other in a transverse direction perpendicular to the longitudinal direction and the vertical direction. The engagement end of the second tower portion may wrap the end surface and at least partially wrap the first side surface and the second side surface.

Optionally, the dimension of the second tower portion may be equal to the dimension of the first tower portion in the longitudinal direction.

Optionally, the second tower portion may extend beyond the mating face of the body in the vertical direction.

Optionally, a protrusion extending in the vertical direction may be disposed on one or two surfaces of the three surfaces of the first tower portion that are at least partially wrapped by the second tower portion, and a groove extending in the vertical direction may be disposed in the engagement end of the second tower portion. The protrusion may be inserted into the groove.

Optionally, a cross-section of the protrusion perpendicular to the vertical direction may be dovetail-shaped.

Optionally, the electrical connector further may comprise a member. The member may be engaged to the first tower portion and the engagement end of the second tower portion to connect the first tower portion with the second tower portion.

Optionally, the member may include a body, a first engagement portion, and a second engagement portion connected to the body. The first engagement portion and the second engagement portion may be engaged to the first tower portion and the engagement end of the second tower portion in the longitudinal direction, respectively.

Optionally, the first engagement portion may include a first insert and a second insert spaced apart in a transverse direction perpendicular to the longitudinal direction and the vertical direction. The first tower portion may include a first side surface and a second side surface opposite each other in the transverse direction. The first side surface may be provided with a first slit extending in the longitudinal direction, and the second side surface may be provided with a second slit extending in the longitudinal direction. The first insert and the second insert may be inserted into the first slit and the second slit, respectively.

Optionally, the first side surface may comprise a first protrusion, the second side surface may comprise a second protrusion, and the engagement end of the second tower portion may comprise a first groove engaged to the first protrusion and a second groove engaged to the second protrusion. The first side surface may comprise a first platform spaced apart from the first protrusion to form the first slit, the second side surface may comprise a second platform spaced apart from the second protrusion to form the second slit. The first platform and the second platform may be disposed outside the second tower portion.

Optionally, the first platform may include two first sub-platforms spaced apart in the longitudinal direction. A first spacing between the two first sub-platforms may be aligned with the first protrusion, and a width of the first spacing may be greater than or equal to a longitudinal dimension of the first protrusion.

Optionally, the second platform includes two second sub-platforms spaced apart in the longitudinal direction. A second spacing between the two second sub-platforms may be aligned with the second protrusion, and a width of the second spacing may be greater than or equal to a longitudinal dimension of the second protrusion.

Optionally, the body may include an end sheet, a first side sheet and a second side sheet. The first side sheet and the second side sheet may extend in the longitudinal direction from two sides of the end sheet opposite each other in the transverse direction, respectively. The first tower portion may be sandwiched between the first side sheet and the second side sheet. The first insert and the second insert may be disposed on the first side sheet and the second side sheet, respectively. The second engagement portion may be disposed on the end sheet, and the second engagement portion may be spaced apart from the first side sheet and the second side sheet in the vertical direction.

Optionally, the second engagement portion may include a first tab and a second tab spaced apart in a transverse direction perpendicular to the longitudinal direction and the vertical direction, the engagement end of the second tower portion may have an outer side surface perpendicular to the longitudinal direction. The outer side surface of the engagement end may be provided with a first opening and a second opening. The first tab and the second tab may be inserted into the first opening and the second opening, respectively. The first tab and the second tab may be disposed on two sides of the first tower portion opposed in the transverse direction, respectively.

Optionally, the first tab may be engaged to the first opening by interference fit, and/or the second tab may be engaged to the second opening by interference fit.

Optionally, the member may include a circuit board connection portion configured for mechanical connection with a circuit board.

Optionally, the member may have outer side surfaces opposite each other in a transverse direction perpendicular to the longitudinal direction and the vertical direction, and the outer side surfaces of the member may be flush with outer side surfaces of the housing.

Optionally, a mechanical strength of a material forming the second tower portion may be greater than or equals to that of a material forming the housing.

Optionally, the first member of the latch may have a first surface and a second surface, the first surface may abut against the latch end of the second tower portion with the latch in the locked position, and the second surface may abut against the latch end of the second tower portion with the latch in the unlocked position. The second tower portion may comprise a channel extending in the vertical direction. The electrical connector further may comprise a second member of the latch passing through the channel. The first member of the latch may be pivotably connected to a first end of the second member of the latch about a pivot axis, and a distance from the pivot axis to the first surface may be less than a distance from the pivot axis to the second surface. A second end of the second member of the latch opposite the first end may be bent toward the inside of the slot, and the second end of the second member of the latch may be below the slot with the latch in the locked position and extends into the slot with the latch in the unlocked position.

Optionally, the second end of the second member of the latch may have a surface facing the mating face, and the surface may be level with a bottom surface of the slot with the latch in the locked position.

Optionally, the electrical connector may comprise a resilient member connected between the second member of the latch and the first tower portion or between the second member of the latch and the second tower portion. The resilient member may have a first deformation amount with the latch in the locked position and a second deformation amount with the latch in the unlocked position. The second deformation amount may be greater than the first deformation amount.

Optionally, a middle portion of the second member of the latch may be provided with a flange, and the resilient member may be sleeved on the second member of the latch and clamped between the flange and the second tower portion.

Optionally, the first tower portion may comprise an aperture, and the resilient member may be disposed inside the aperture.

Optionally, a cross-section of the channel may be adapted to a cross-section of the second member of the latch.

Some embodiments relate to an electrical connector. The electrical connector may comprise a connector body, a first member of the latch and a second member of the latch. The connector body may be provided with a slot extending in a longitudinal direction. The second member of the latch may be movably disposed in the connector body in a vertical direction perpendicular to the longitudinal direction. The first member of the latch may be pivotably connected to a first end of the second member of the latch between a locked position and an unlocked position, a second end of the second member of the latch opposite the first end may be bent toward an inner of the slot, and the first member of the latch may be configured to move the second member of the latch in the vertical direction when being pivoted between the locked position and the unlocked position. The second end of the second member of the latch may be below the slot with the latch in the locked position. The second end of the second member of the latch may be inside the slot with the latch in the unlocked position.

Optionally, the first member of the latch may have a first surface and a second surface, the first surface may abut against the connector body with the latch in the locked position, and the second surface may abut against the connector body with the latch in the unlocked position. A first distance from a pivot axis of the first member of the latch to the first surface may be less than a second distance from the pivot axis to the second surface.

Optionally, a difference between the second distance and the first distance may be equal to a movable distance of the second member of the latch in vertical direction.

Optionally, an transition surface may connect the first surface and the second surface.

Optionally, the first surface and the second surface may be perpendicular to each other.

Optionally, the first surface may have a first dimension in the longitudinal direction with the latch in the locked position, the second surface may have a second dimension in the longitudinal direction with the latch in the unlocked position, and the first dimension may be greater than the second dimension.

Optionally, the slot may elongate in the longitudinal direction, the first dimension of the first surface may be greater than or equal to half of a distance from the slot to an outer side surface of the second tower portion perpendicular to the longitudinal direction.

Optionally, the first member of the latch may have a cavity, and the first end of the second member of the latch may extend into the cavity. The first end of the second member of the latch may abut against a sidewall of the cavity with the latch in the locked position.

Optionally, the electrical connector may comprise a resilient member disposed between the second member of the latch and the connector body. The resilient member may have a first deformation amount with the latch in the locked position and a second deformation amount with the latch in the unlocked position, and the second deformation amount may be greater than the first deformation amount.

Optionally, the connector body may include a housing and a second tower portion. The housing may include a body extending in the longitudinal direction and a first tower portion disposed at an end of the body. The second tower portion may have an engagement end engaged to the first tower portion and a latch end opposite the engagement end in the vertical direction. The second tower portion may comprise a channel, and the second member of the latch may pass through the channel and the first end of the second member of the latch may extend beyond the latch end.

Optionally, the second member of the latch may be sleeved with a resilient member. A portion of the second member of the latch inside the first tower portion may be provided with a flange, and the resilient member may be clamped between the flange and the second tower portion.

Optionally, the first tower portion may comprise an aperture, and the resilient member may be disposed in the aperture.

Optionally, the second end of the second member of the latch may have a surface facing the slot, and the surface may be level with a bottom surface of the slot with the latch in the locked position.

Some embodiments relate to an electrical connector. The electrical connector may comprise a housing and a member. The housing may include a body elongating in a longitudinal direction and a first tower portion disposed at an end of the housing. The housing may have a mating face and a mounting face opposite each other in a vertical direction perpendicular to the longitudinal direction. The mating face may be provided with a slot, and the first tower portion may protrude beyond the mating face in the vertical direction. The member may be engaged to the first tower portion. The member may at least partially wrap three surfaces of the first tower portion, and the member may include a circuit board connection portion configured for mechanical connection with a circuit board.

Optionally, the member may include a body and a first engagement portion. The body may include an end sheet, a first side sheet and a second side sheet, and the first side sheet and the second side sheet may extend in the longitudinal direction from two sides of the end sheet opposite each other in a transverse direction perpendicular to the vertical direction. The body may at least partially wrap the three surfaces of the first tower portion, the first engagement portion may be disposed on the first side sheet and/or the second side sheet, and the first engagement portion may be engaged to the first tower portion.

Optionally, the first tower portion may include a first side surface and a second side surface opposite each other in the transverse direction. The first side surface may be provided with a first slit extending in the longitudinal direction, and the second side surface may be provided with a second slit extending in the longitudinal direction. The first engagement portion may include a first insert disposed on the first side sheet and a second insert disposed on the second side sheet, and the first insert and the second insert may be inserted into the first slit and the second slit, respectively.

Optionally, the first side sheet may wrap a portion of the first side surface between the first slit and the mounting face.

Optionally, the second side sheet may wrap a portion of the second side surface between the second slit and the mounting face.

Optionally, the electrical connector may comprise a second tower portion and a first member of the latch. The second tower portion may have an engagement end engaged to the first tower portion and a latch end opposite the engagement end in the vertical direction. The member may comprise a second engagement portion engaged to the engagement end. The first member of the latch may be movably disposed at the latch end of the second tower portion between a locked position and an unlocked position.

Optionally, the second engagement portion may include a first tab and a second tab spaced apart in the transverse direction. The engagement end of the second tower portion may have an outer side surface perpendicular to the longitudinal direction, and the outer side surface of the second tower portion may be provided with a first opening and a second opening. The first tab and the second tab may be inserted into the first opening and the second opening, respectively. The first tab and the second tab may be disposed on two sides of the first tower portion opposed in the transverse direction, respectively.

Optionally, the first tab may be engaged to the first opening by interference fit, and/or the second tab may be engaged to the second opening by interference fit.

Optionally, the electrical connector may comprise a second member of the latch and a first member of the latch. The second member of the latch movably may pass through the second tower portion in a vertical direction perpendicular to the longitudinal direction, and a first end of the second member of the latch may extend beyond the latch end of the second tower portion. The first member of the latch may be pivotably connected to the first end of the second member of the latch between the locked position and the unlocked position. A second end of the second member of the latch opposite the first end may be bent toward the inside of the slot, and the first member of the latch may be configured to move the second member of the latch in the vertical direction when being pivoted between the locked position and the unlocked position. The second end of the second member of the latch may be below the slot with the latch in the locked position and the second end of the second member of the latch may be inside the slot with the latch in the unlocked position.

Optionally, the first member of the latch may have a first surface and a second surface, the first surface may abut against the latch end of the second tower portion with the latch in the locked position, the second surface may abut against the latch end of the second tower portion with the latch in the unlocked position. A first distance from a pivot axis of the first member of the latch to the first surface may be less than a second distance from the pivot axis of the first member of the latch to the second surface.

Optionally, the electrical connector may comprise a resilient member disposed between the second member of the latch and the second tower portion or between the second member of the latch and the first tower portion. The resilient member may have a first deformation amount with the latch in the locked position and a second deformation amount with the latch in the unlocked position. The second deformation amount may be greater than the first deformation amount.

Optionally, a middle portion of the second member of the latch may be provided with a flange, and the resilient member may be sleeved on the second member of the latch and clamped between the flange and the second tower portion.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of a portion of an electronic system having an electrical connector connected with an electronic card, showing a latch of the electrical connector in a locked position, according to some embodiments;

FIG. 2 is a front view of the electronic system of FIG. 1, showing the latch of the electrical connector in an unlocked position;

FIG. 3 is a partially exploded, perspective view of the electronic system of FIG. 1;

FIG. 4a is a perspective view of the electrical connector of the electronic system of FIG. 1;

FIG. 4b is a top view of a portion of the electrical connector of FIG. 4a;

FIG. 5a is a perspective view of a portion of the electrical connector of FIG. 4a, showing an insulating housing, with a second tower portion and member hidden;

FIG. 5b is another perspective view of the portion of the electrical connector of FIG. 5a;

FIG. 5c is a front view of the portion of the electrical connector of FIG. 5a;

FIG. 6a is a perspective view of the second tower portion of the electrical connector of FIG. 4a;

FIG. 6b is another perspective view of the second tower portion of the electrical connector of FIG. 6a;

FIG. 7a is a perspective view of a portion of the electrical connector of FIG. 4a, showing the insulating housing and second tower portion, with the member hidden;

FIG. 7b is a cross-sectional view of the portion of the electrical connector of FIG. 7a, taken by a plane perpendicular to a vertical direction;

FIG. 8a is a perspective view of a portion of the electrical connector of FIG. 4a, showing the insulating housing and member, with the second tower portion hidden;

FIG. 8b is a cross-sectional perspective view of the portion of FIG. 8a, taken by a plane perpendicular to a transverse direction;

FIG. 9a is a perspective view of the member of the electrical connector of FIG. 4a;

FIG. 9b is a perspective view of the member of FIG. 9a;

FIG. 10 is a perspective view of a portion of the electrical connector of FIG. 4a;

FIG. 11a is a cross-sectional view of a portion of the electronic system of FIG. 1, with the latch of the electrical connector in the locked position;

FIG. 11b is a cross-sectional view of the portion of the electronic system of FIG. 11a, with the latch in the unlocked position;

FIG. 12 is a side view of a first member of the latch of the electrical connector of FIG. 4a, showing the locked position in solid lines and the unlocked position in dashed lines;

FIG. 13 is a perspective view of the first member of the latch of FIG. 12; and

FIG. 14 is a perspective view of a second member of the latch of the electrical connector of FIG. 4a.

The above accompanying drawings include the following reference signs:
10, electrical connector; 100, insulating housing; 101, mating face; 102, mounting face; 103, first slot; 104, rib; 110, body; 120, first tower portion; 121, end surface; 122, first side surface; 123, second side surface; 124, third side surface; 125, fourth side surface; 130, protrusion; 131, first protrusion; 132, second protrusion; 140, first platform; 140a, 140b, first sub-platform; 150, second platform; 150a, 150b, second sub-platform; 161, first slit; 162, second slit; 170, board lock receiver; 180, aperture; 200, second tower portion; 201, channel; 202, second slot; 210, latch end; 220, engagement end; 221, groove; 221a, first groove; 221b, second groove; 230, outer side surface; 231, first opening; 232, second opening; 240, opening; 240a, 240b, opening sidewall; 300, conductive element; 310, mating portion; 320, mounting tail; 400, first member of the latch; 401, first surface; 402, second surface; 403, transition surface; 404, first hole; 405, cavity; 405a, first cavity sidewall; 405b, second cavity sidewall; 405c, third cavity sidewall; 410, operating portion; 420, projection; 430, pin; 500, second member of the latch; 510, first end; 520, second end; 521, surface; 530, flange; 540, connection surface; 550, second hole; 600, resilient member; 700, member; 710, body; 711, end sheet; 712, first side sheet; 713, second side sheet; 720, first engagement portion; 721, first insert; 722, second insert; 730, second engagement portion; 731, first tab; 732, second tab; 740, circuit board connection portion; 741, first foot; 742, second foot; 743, third foot; 744, fourth foot; 20, electronic card; 22, notch; 40, printed circuit board; 41, pad; 42, hole; 43, board lock hole; 50, board lock.

### DETAILED DESCRIPTION

The Inventors have recognized and appreciated connector design techniques that economically enable reliable operation of electronic systems, such as systems having tall cards. Tall cards may enable greater functionality of the system, as tall cards may have greater heights than standard cards so as to provide more functions and/or storage (e.g., high-capacity memory modules). For example, a standard DDR5 card has a height of about 32 mm and notches disposed about ½ height of the card or lower configured for engaging latches. A tall card would have a greater height, which can be, for example, one and half or twice of the height of a standard card.

The Inventors have recognized and appreciated that connectors with conventional designs, however, would need to be larger in multiple dimensions than connectors designed for standards cards in order to provide the strengths for reliable connections between tall cards and the connectors. The enlarged connectors with conventional designs would therefore not be compatible with industry standards and may cause various problems such as requiring larger mounting areas on a printed circuit board and reduced spacing between adjacent connectors, which would reduce heat dissipation in the system and also threaten reliable operation of the system. The Inventors have recognized and appreciated designs for electrical connectors that can provide reliable connections for electronic systems with tall cards, while being compatible with physical requirements of industry standards in many dimensions.

According to aspects of the present application, an electrical connector may have a housing body, a tower extending from an end of the housing body, and a latch configured to cooperate with tall cards. The tower may extend in a height direction beyond a position of a notch of a standard card. The tower may have a first portion extending from the end of the housing body and a second portion coupled to the first portion. The latch may have a first member pivotable about an end of a second member so as to move the second member in a vertical direction when the latch moves between a locked position and an unlocked position. Such a configuration enables the connector to provide reliable connections for tall cards, while compatible with physical requirements of industry standards, for example, in length/width directions.

An electrical connector according to some embodiments of the present disclosure is described in detail hereinbelow in conjunction with the drawings. A vertical direction Z-Z, a longitudinal direction X-X and a transverse direction Y-Y may be shown in the drawings. The vertical direction Z-Z, the longitudinal direction X-X and the transverse direction Y-Y may be perpendicular to one another. The vertical direction Z-Z may refer to a height direction of the electrical connector, which in this example is a direction from the mounting interface of the connector towards a surface containing slots that receive a mating component. The longitudinal direction X-X may refer to a length direction of the electrical connector. The transverse direction Y-Y may refer to a width direction of the electrical connector, with the connector being elongated in the length direction and narrower in the width direction than the length direction.

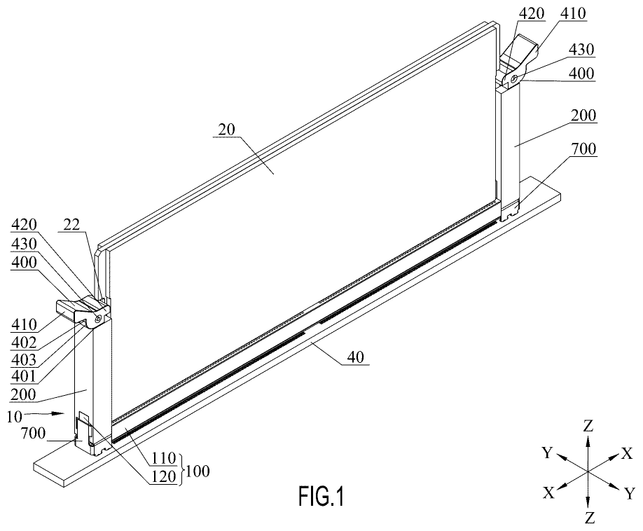

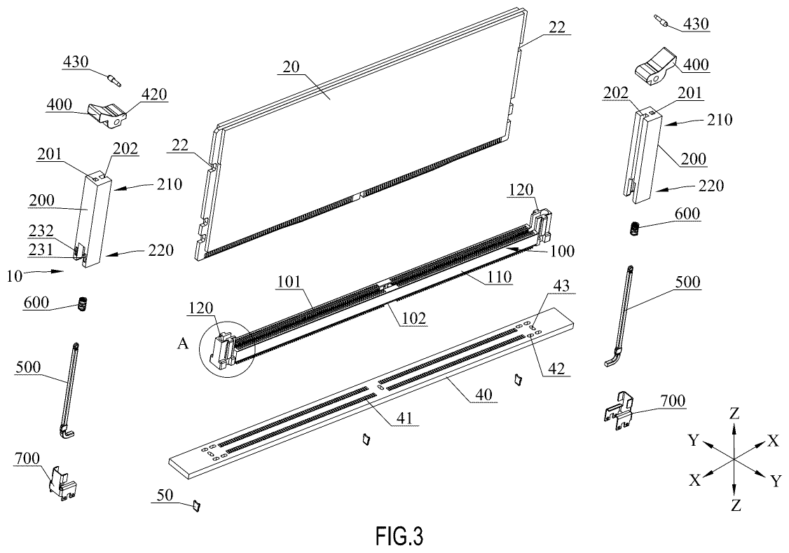

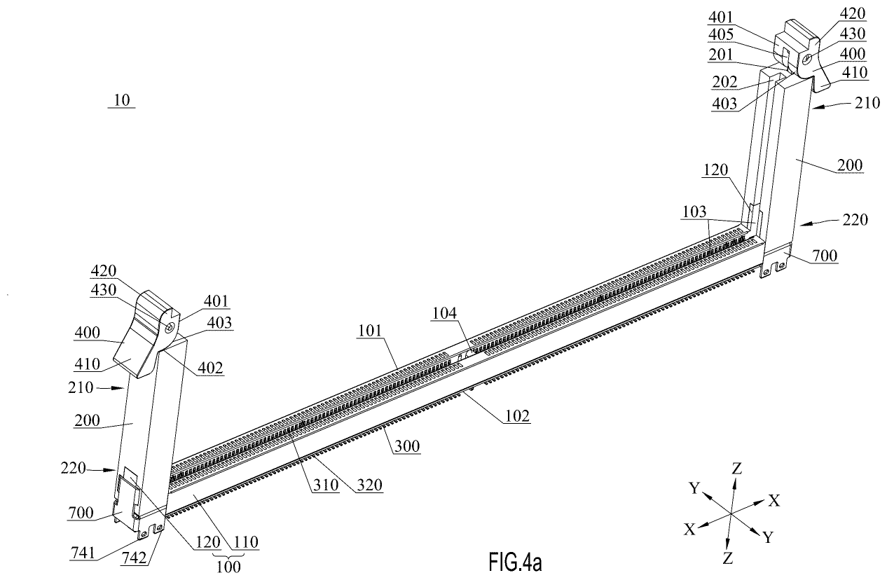

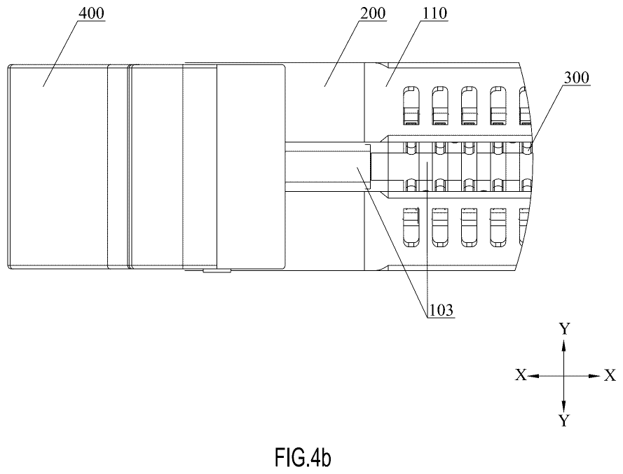

As shown in FIGS. 1 and 4a-4b, an electrical connector 10 may include an insulating housing 100. The insulating housing 100 may be molded from an insulating material, such as plastic. The insulating housing 100 may be a one-piece member. As shown in FIGS. 3 and 4a-4b, the insulating housing 100 may have an mating face 101 and a mounting face 102. The mating face 101 and the mounting face 102 may be arranged oppositely in the vertical direction Z-Z. The mating face 101 may be provided with a first slot 103 elongating in the longitudinal direction X-X. The first slot 103 may be recessed toward the mounting face 102 in the vertical direction Z-Z. As shown in FIGS. 4a-4b, a plurality of conductive elements 300 may be held by the insulating housing 100. Adjacent conductive elements 300 may be spaced apart from each other to electrically insulate from each other. The conductive elements 300 may be made of conductive materials, such as metal. The conductive elements 300 each may be an elongated one-piece member. Each conductive element 300 may include a mating portion 310 and a mounting tail 320 at two ends opposed in the extension direction of the conductive element 300. The mating portion 310 may be used for electrical connection to circuitry of the electronic card 20. The electronic card 20 includes but not limited to graphics card or memory card. The mounting tail 320 may be connected to a pad 41 on the printed circuit board 40 by reflow soldering. In this way, the electronic card 20 may be electrically connected to the printed circuit board 40 via the electrical connector 10, thereby interconnecting the circuitry in the electronic card 20 with the circuitry in the printed circuit board 40. The mating portion 310 of each conductive element 300 may extend adjacent to the mating face 101. Exemplarily, the mating portion 310 may curve into the first slot 103 of the mating face 101. The mounting tail 320 of each conductive element 300 may extend beyond the mounting face 102. The conductive elements 300 may be arranged in two columns on two sides of the first slot 103. Each column may be parallel to the longitudinal direction X-X. Optionally, the two columns of conductive elements 300 may be aligned with each other in the longitudinal direction X-X. Optionally, the two columns of conductive elements 300 are staggered in the longitudinal direction X-X to increase the space between the conductive elements 300 in order to reduce crosstalk.

As shown in FIG. 4a, the insulating housing 100 may comprise a body 110 and a first tower portion 120. The body 110 may extend in the longitudinal direction X-X. The first tower portion 120 may be disposed at an end of the body 110. Exemplarily, there may be only a first tower portion 120 at one end of the body 110. Optionally, there may be two first tower portions 120 at opposite ends of the body 110 in the longitudinal direction X-X. The first tower portion 120 may protrude beyond the mating face 101 in the vertical direction Z-Z. The first slot 103 may extend from the body 110 into the first tower portion 120. The plurality of conductive elements 300 may be held by the body 110. A rib 104 may be disposed in the first slot 103. The rib 104 may connect a pair of opposite sidewalls of the first card 103 in the transverse direction Y-Y, which may enhance mechanical strength of the body 110. Optionally, in the longitudinal direction X-X, the rib 104 may not be disposed in the center of the first slot 103, thereby serving to dummy-proof when an electronic card 20 is inserted.

As shown in FIGS. 1 to 4a, the electrical connector 10 may comprise a second tower portion 200. The second tower portion 200 and the first tower portion 120 may be made of the same material or different materials. The second tower portion 200 may be in a columnar structure extending in the vertical direction Z-Z. The external dimensions of the second tower portion 200 may be adapted to the external dimensions of the insulating housing 100. In the transverse direction Y-Y, the width of the second tower portion 200 may be equal to the width of the body 110 and/or the width of the first tower portion 120. In the longitudinal direction X-X, the length of the second tower portion 200 may be equal to the length of the first tower portion 120. The second tower portion 200 may have an engagement end 220 and a latch end 210. The engagement end 220 and the latch end 210 may be opposite each other in the vertical direction Z-Z. With respect to the placement state of the electrical connector 10 as shown in FIGS. 1-4, the engagement end 220 may be a lower end of the second tower portion 200 and the latch end 210 may be an upper end of the second tower portion 200. The engagement end 220 may be engaged to the first tower portion 120 by any suitable method. The connection method is not limited herein. A second slot 202 that extends in the vertical direction Z-Z may be disposed in the second tower portion 200. The second slot 202 may be aligned with an end of the first slot 103, and the second slot 202 may be available for insertion of a side edge of the electronic card 20. The second slots 202 on a pair of second tower portions 200 may be opposite each other. The pair of second slots 202 together with the first slot 103 form a slot of the electrical connector 10.

As shown in FIGS. 1 to 4a-4b, the electrical connector 10 may comprise a first member 400 of the latch. The first member 400 of the latch may be used to lock and release the electronic card 20 connected to the insulating housing 100 and the second tower portion 200. The first member 400 of the latch may be molded from an insulating material, such as plastic, by molding process. The first member 400 of the latch may be disposed at the latch end 210 of the second tower portion 200. The first member 400 of the latch may be movably disposed at the latch end 210 between a locked position and an unlocked position. The first member 400 of the latch may be movably relative to the latch end 210 in the manner of being pivotable, translatable, and the like. Optionally, the first member 400 of the latch may be pivotably connected to the latch end 210 between the locked position and the unlocked position. In the embodiments to be described later, the first member 400 of the latch may be connected to other components such as, a second member 500 of the latch. Regardless of which component the first member 400 of the latch is connected to, the first member 400 of the latch is at the position where the latch end 210 is. As a result, the distance from the first member 400 of the latch to the insulating housing 100 can be increased such that the first member 400 of the latch can be locked to the electronic card 20 at a higher position. A notch 22 (e.g., a tall DDR card) can be higher in a tall electronic card 20 than a standard DDR card such that the first member 400 of the latch, the insulating housing 100 and the second tower portion 200 can fix more edges of the electronic card 20 in place. Exemplarily, the first member 400 of the latch may be disposed above the center of gravity of the electronic card 20. As a result, firmness and reliability of the connection between the electronic card 20 and the electrical connector 10 can be improved.

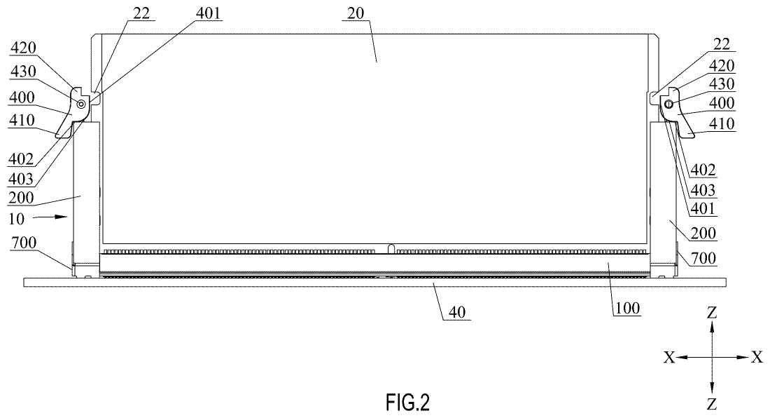

As shown in FIG. 1, by operating an operating portion 410 of the first member 400 of the latch, the first member 400 of the latch may be pivoted between the locked position and the unlocked position. With the first member 400 of the latch in the locked position, a projection 420 of the first member 400 of the latch may extend into the notch 22 in the edge of the electronic card 20 to position the edge of the notch 22, and thus the first member 400 of the latch can lock the electronic card 20 onto the insulating housing 100 and the second tower portion 200. With the first member 400 of the latch in the unlocked position in FIG. 2, the first member 400 of the latch is pivoted outwardly and the projection 420 exits the notch 22, allowing the electronic card 20 to be detached from the insulating housing 100 and the second tower portion 200. Optionally, to facilitate the operation of the first member 400 of the latch, the operating portion 410 may be provided with an anti-slip structure to increase friction, such as one or more of recesses and raised pattern. The anti-slip structure helps a user operate the first member 400 of the latch between the locked position and the unlocked position, in particular to pivot from the locked position to the unlocked position.

In the electrical connector 10 provided in the embodiments of the present disclosure, with the second tower portion 200 being joined to the first tower portion 120 of the insulating housing 100, the total height of the tower formed by both the first tower portion 120 and the second tower portion 200 may thereby be increased. The second tower portion 200 and the insulating housing 100 may be manufactured separately and assembled together. The plurality of conductive elements 300 are held by the insulating housing 100 to ensure that the plurality of conductive elements 300 are electrically insulated from each other, thus the insulating housing 100 may be made of an insulating material and processed by molding process. The second tower portion 200 is not necessary to be insulating and has a relatively simpler structure, thus more choices are available in terms of material and manufacturing process. Exemplarily, the second tower portion 200 may be made of a material with greater strength, such as metal, ceramic, and the like. As a result, although the electrical connector 10 can be adapted to a tall electronic card because of a significantly increased overall height of the tower by the second tower portion 200, the electrical connector 10 may still have sufficiently great mechanical strength. Thus, the stability of the connection between the electronic card 20 and the electrical connector 10 can be ensured. In addition, after increasing the overall height of the tower by the second tower portion 200, the first member 400 of the latch may be higher in position, whereby half or more than half of the edges of the electronic card 20 can be secured onto the electrical connector 10. Optionally, with reasonable selection of the length of the second tower portion 200, the center of gravity of the electronic card 20 can lie within the region surrounded by the insulating housing 100 and the second tower portion 200, thereby further enhancing the stability of the connection between the electronic card 20 and the electrical connector 10.

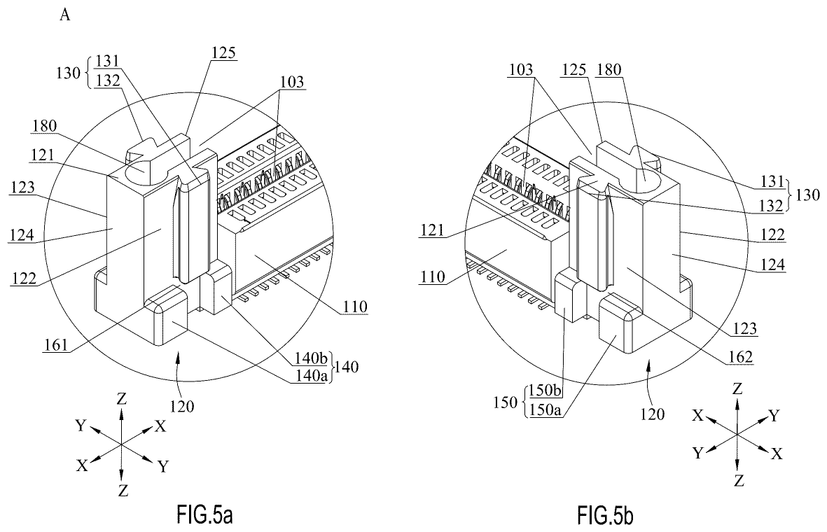

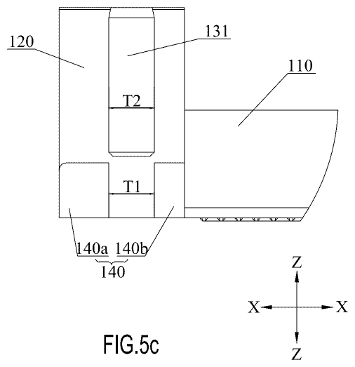

Exemplarily, as shown in FIG. 4a, the engagement end 220 of the second tower portion 200 at least partially wraps three surfaces of the first tower portion 120. Exemplarily, as shown in FIGS. 5a and 5b, the first tower portion 120 may include an end surface 121, a first side surface 122, a second side surface 123, a third side surface 124 and a fourth side surface 125. The end surface 121 may face the second tower portion 200 in the vertical direction Z-Z. In the embodiments as shown in the drawings, the end surface 121 may be disposed at the top of the first tower portion 120. The first side surface 122 and the second side surface 123 may be opposite each other in the transverse direction Y-Y. The third side surface 124 and the fourth side surface 125 may be opposite each other in the longitudinal direction X-X. The third side surface 124, along with the first side surface 122 and the second side surface 123, may face toward the outside of the insulating housing 100, and thus they may also be referred to as outer sides. The fourth side surface 125 faces toward the inside of the insulating housing 100, and the first slot 103 may extend from the body 110 into the first tower portion 120 via the fourth side surface 125.

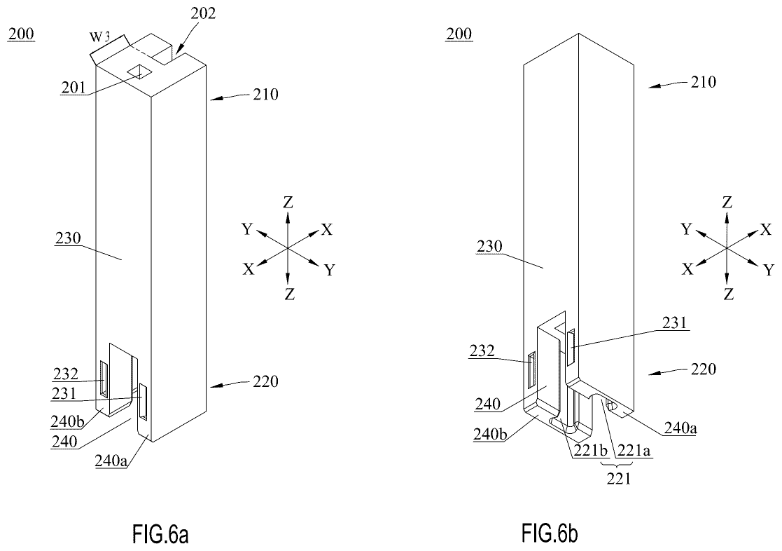

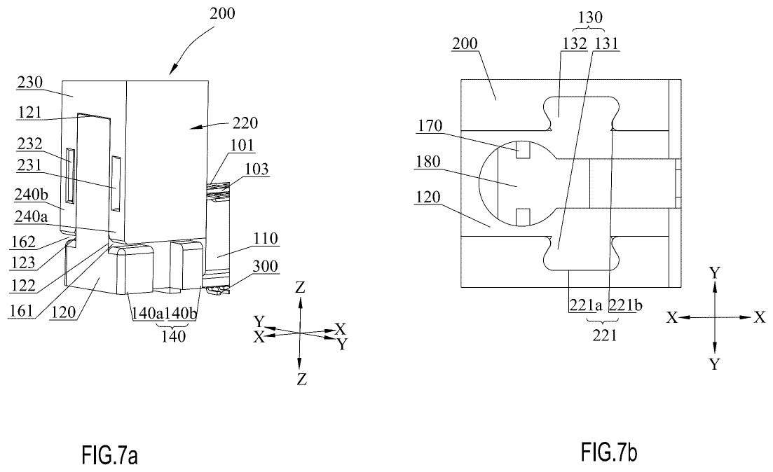

The first tower portion 120 and the second tower portion 200 may be arranged in the vertical direction Z-Z. The engagement end 220 of the second tower portion 200 may cover at least a portion of the end surface 121. Apart from the end surface 121, the three surfaces of the first tower portion 120 that are at least partially wrapped by the engagement end 220 may include two of the first side surface 122, the second side surface 123, the third side surface 124 and the fourth side surface 125. It should be appreciated that the engagement end 220 of the second tower portion 200 may also at least partially wrap three or four of the first side surface 122, the second side surface 123, the third side surface 124 and the fourth side surface 125. In some embodiments, since the end of the first slot 103 passes through the fourth side surface 125, the engagement end 220 of the second tower portion 200 may at least partially wrap the first side surface 122, the second side surface 123 and the third side surface 124. Exemplarily, the engagement end 220 of the second tower portion 200 may be provided with an opening 240 into which the first tower portion 120 may be inserted, as shown in FIGS. 6a and 7a.

Exemplarily, the engagement end 220 of the second tower portion 200 may wrap the end surface 121 and at least partially wrap the first side surface 122 and the second side surface 123. Optionally, the electronic card 20 has a sheet-like structure with the dimension in the longitudinal direction X-X significantly larger than the dimension in the transverse direction Y-Y. When subjected to an impact force in the transverse direction Y-Y, the electronic card 20 may sway significantly in the transverse direction Y-Y. The dimension of the electrical connector 10 in the transverse direction Y-Y may be very small, e.g., around 6.5 mm for a standard DDR5 electrical connector, so that the sway of the electronic card 20 in the transverse direction Y-Y is particularly prone to damaging the insulating housing 100. In some embodiments, the second tower portion 200 may at least partially wrap the two opposed side surfaces of the first tower portion 120 in the transverse direction Y-Y so that the impact resistance of the first tower portion 120 in the transverse direction Y-Y can be improved. As described herein, the end of the first slot 103 may extend into the first tower portion 120, and the second tower portion 200 can resist transverse impact force applied to the electronic card 20 on opposite sides of the slot 103 in the transverse direction Y-Y, and thus can improve the impact resistance performance of the insulating housing 100 in the transverse direction Y-Y.

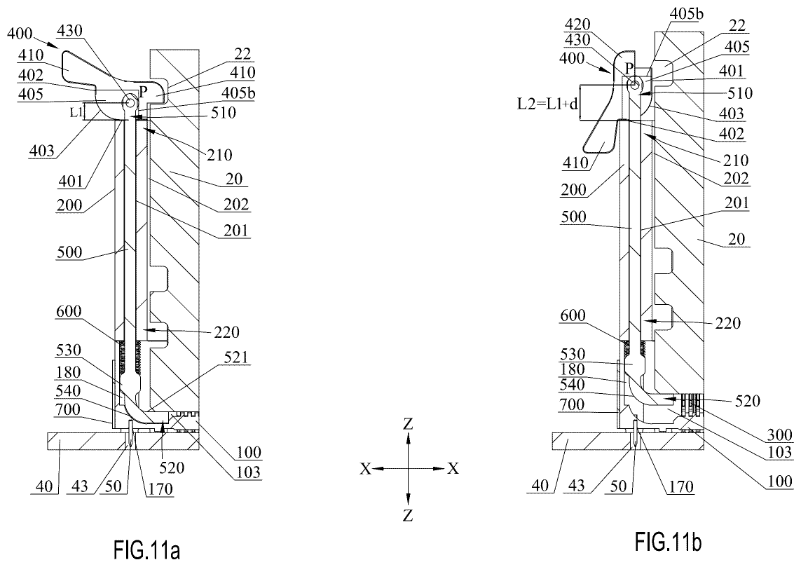

Exemplarily, as shown in FIGS. 7a and 7b, the dimension of the second tower portion 200 in the longitudinal direction X-X may be comparable to that of the first tower portion 120. Two side surfaces of the second tower portion 200 opposite each other in the longitudinal direction X-X may be coplanar with the third side surface 124 and the fourth side surface 125 of the first tower portion 120, respectively. In this way, the first tower portion 120 may have a sufficiently large dimension in the longitudinal direction X-X, such as to comply with industrial standards like Joint Electron Device Engineering Council (JEDEC) standards. Such a configuration enables the first tower portion 120 to have sufficient mechanical strength. Moreover, the first tower portion 120 also needs to provide an aperture 180 for accommodating the resilient member 600 (FIGS. 3, 11a, 11b). The longitudinal dimensions of the second tower portion 200 and the first tower portion 120 are consistent, which also allows the first tower portion 120 to have a sufficiently large space to provide the aperture 180. Furthermore, the second tower portion 200 and the first tower portion 120 may flush in the longitudinal direction X-X, which may make the overall structure of the electrical connector 10 compact. With this configuration, especially in the case where the engagement end 220 of the second tower portion 200 at least partially wraps the first side surface 122 and the second side surface 123 of the first tower portion 120, the second tower portion 200 may serve to reinforce the first tower portion 120 in the longitudinal direction X-X.

Exemplarily, the second tower portion 200 may extend beyond the mating face 101 of the body 110 in the vertical direction Z-Z, as shown in FIG. 7a. In the illustrated state of placement, the second tower portion 200 extends downwardly below the mating face 101. The more the second tower portion 200 extends beyond the mating face 101, the better the second tower portion 200 may reinforce the first tower portion 120. In the illustrated embodiment, a lower end of the second tower portion 200 is substantially at a position midway between the mating face 101 and the mounting face 102. The second tower portion 200 does not cover a first platform 140 and a second platform 150 on the first tower portion 120. As will be mentioned later, the first platform 140 and the second platform 150 are used to hold a member 700, and the first platform 140 and the second platform 150 need to exert an upward force to the member 700. The second tower portion 200 may extend to a position substantially midway between the mating face 101 and the mounting face 102, such that the first platform 140 and the second platform 150 both have a large vertical dimension. Optionally, however, the lower end of the second tower portion 200 may extend further downwardly with respect to the illustrated embodiment, even to a level of the mounting face 102, in which case the member 700 may not be required or reasonably modified in structure.

Exemplarily, as shown in FIGS. 5a to 5c, a protrusion 130 may be disposed on one or more of the three surfaces of the first tower portion 120 that are at least partially wrapped by the second tower portion 200. The protrusion 130 may extend in the vertical direction Z-Z. A cross-section of the protrusion 130 perpendicular to the vertical direction Z-Z may be semicircular, trapezoidal, or any suitable shape. Where a plurality of surfaces are provided with the protrusions 130, the protrusions 130 may have the same structure or different structures, which is not limited herein. As shown in FIG. 6b, a groove 221 may be provided in the engagement end 220 of the second tower portion 200. The groove 221 may extend in the vertical direction Z-Z. The protrusion 130 may be inserted into the groove 221. The groove 221 may be adapted to the protrusion 130 in shape. With this configuration, the assembly of the electrical connector 10 can be more convenient as the second tower portion 200 can be quickly engaged to the first tower portion 120 in the vertical direction Z-Z by cooperation of the protrusions 130 and the grooves 221. The second tower portion 200 can be assembled downwardly to the first tower portion 120. An upper end of the protrusion 130 may be provided with chamfers, which can serve to guide the second tower portion 200 during the assembly of the second tower portion 200 to the first tower portion 120.

Exemplarily, as shown in FIG. 5a, the cross-section of the protrusion 130 perpendicular to the vertical direction Z-Z may be dovetail-shaped. With this configuration, after the protrusion 130 is connected to the groove 221 in place, even if only one groove 221 is provided, it may still serve to position the protrusion 130 in the longitudinal direction X-X and the transverse direction Y-Y, thereby restricting the freedom of motion of the second tower portion 200 with respect to the first tower portion 120 in the longitudinal direction X-X and the transverse direction Y-Y. Accordingly, the connection between the first tower portion 120 and the second tower portion 200 is more secure.

Although in the illustrated embodiment, the protrusion 130 is disposed on the first tower portion 120 and the groove 221 is disposed in the second tower portion 200, Optionally, it is also possible to interchange the protrusion and the groove, i.e., have the protrusion on the second tower portion 200 and the groove in the first tower portion 120. Optionally, where there are a plurality of engagement pairs, each comprising a protrusion and groove, it is possible to have a protrusion(s) in a portion of the engagement pairs disposed on the second tower portion 200 and an protrusion(s) in other portion of the engagement pairs on the first tower portion 120. As described herein, the insulating housing 100 may be processed by injection molding, which has certain requirements for the thickness of the thinnest portion. If the groove is disposed in the first tower portion 120, it may result in the first tower portion 120 being locally thinner, which may not satisfy the requirements of the manufacturing process and therefore result in the mechanical strength of the first tower portion 120 not meeting the requirements. Optionally, the protrusions 130 are disposed on the first tower portion 120, and the grooves 221 in the second tower portion 200.

Exemplarily, as shown in FIGS. 5a and 5b, the protrusion 130 may include a first protrusion 131 disposed on the first side surface 122 and a second protrusion 132 disposed on the second side surface 123. In this way, the first protrusion 131 and the second protrusion 132 may be disposed on two sides of the first slot 103 opposite each other in the transverse direction Y-Y, respectively. The first protrusion 131 and the second protrusion 132 may be disposed symmetrically on both sides of the first slot 103. Optionally, the first protrusion 131 and the second protrusion 132 may be staggered by a certain distance in the longitudinal direction X-X. In addition, the first protrusion 131 and the second protrusion 132 may also have different structures unlike those as shown in the drawings. Correspondingly, as shown in FIG. 6b, the groove 221 in the engagement end 220 of the second tower portion 200 may include a first groove 221a and a second groove 221b. The first groove 221a and the second groove 221b may be disposed in opening sidewalls 240a and 240b of the opening 240 opposite in the transverse direction Y-Y. The first protrusion 131 may be engaged to the first groove 221a. The second protrusion 132 may be engaged to the second groove 221b. The engagement end 220 of the second tower portion 200 can be reliably connected to the first tower portion 120 in both the longitudinal direction X-X and the transverse direction Y-Y by providing the first protrusion 131 and the second protrusion 132 on two opposite sides of the first tower portion 120, respectively.

Exemplarily, as shown in FIGS. 1 to 4a-4b, the electrical connector 10 may comprise a member 700. The member 700 may be configured to reinforce the connection between the first tower portion 120 and the second tower portion 200. The member 700 may be made of a material with greater strength, such as plastic, ceramic, metal, and the like. Optionally, the member 700 may be made of a metallic material. Metallic material is stronger and processed cost-effectively. Optionally, the member 700 may be an integrated sheet metal member. In this way, the member 700 is greater in strength and is processed more cost-effectively. Optionally, the member 700 may be engaged to the first tower portion 120 and the engagement end 220 of the second tower portion 200 so as to connect the first tower portion 120 and the engagement end 220 of the second tower portion 200 together. With this configuration, the first tower portion 120 and the second tower portion 200 can be further connected by the member 700. Optionally, the member 700 may connect the first tower portion 120 to a printed circuit board to ensure the reliability of the connection between the insulating housing 100 and the printed circuit board. Optionally, the member 700 may connect the first tower portion 120 and the engagement end 220 of the second tower portion 200 to the printed circuit board to ensure the reliability of the connection among the three, namely the insulating housing 100, the second tower portion 200 and the printed circuit board. Optionally, the member 700 may connect the engagement end 220 of the second tower portion 200 to the printed circuit board. Since the first tower portion 120 is sandwiched between the second tower portion 200 and the printed circuit board, it can also enable the reliable connection among the three, namely the insulating housing 100, the second tower portion 200 and the printed circuit board. As can be seen, in different embodiments, the member 700 may play different roles of connection. Depending on the different roles of the member 700, it may have different structures.

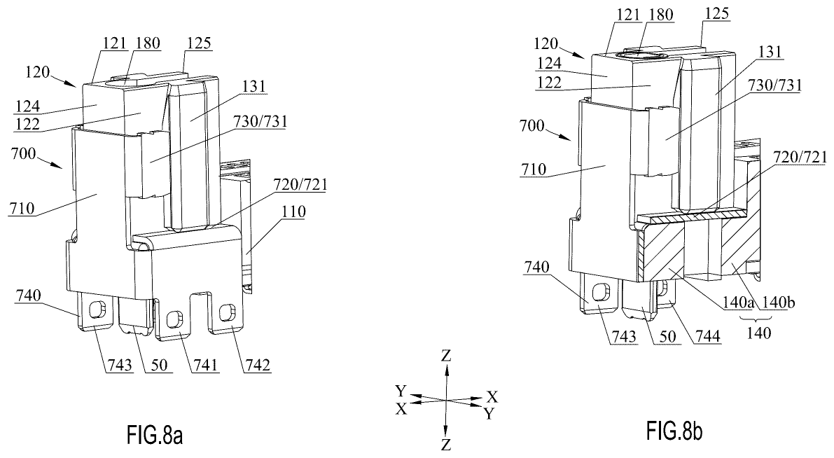

Regardless of the connection role played by the member 700, the member 700 may at least partially wrap three surfaces of the first tower portion 120. Optionally, the fourth side surface 125 of the first tower portion 120 is connected to the body 110, and referring to FIGS. 5a, 5b, 8a and 8b in conjunction, the member 700 may at least partially wrap the first side surface 122, the second side surface 123, and the third side surface 124 of the first tower portion 120. The member 700 may wrap the portions of the first side surface 122 and the second side surface 123 that are not wrapped by the second tower portion 200, whereby the second tower portion 200 together with the member 700 may provide improved reinforcement and to the first tower portion 120 in the transverse direction Y-Y. In addition, the member 700 may at least partially wrap the third side surface 124.

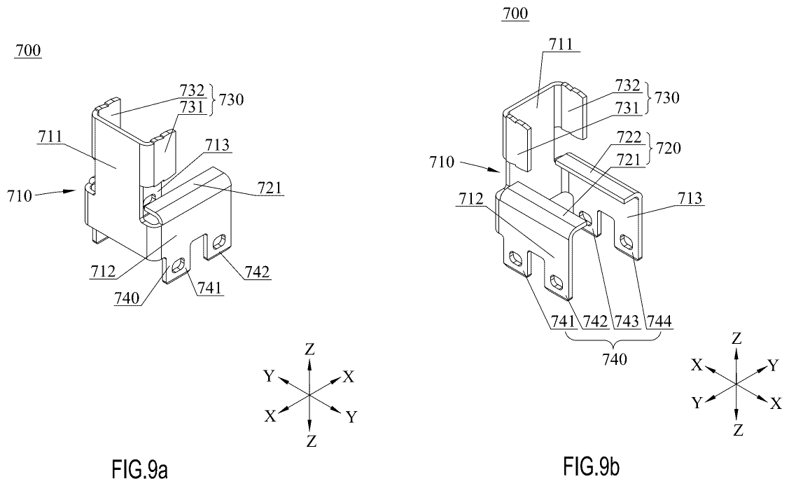

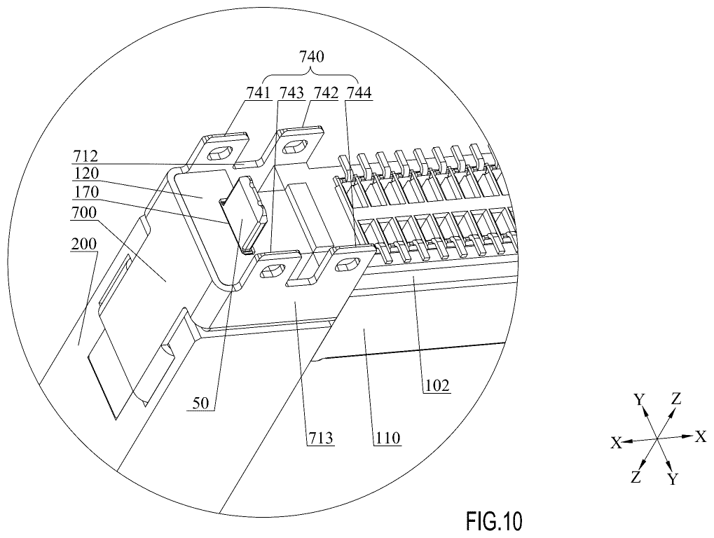

Exemplarily, as shown in FIGS. 8a, 8b, 9a, and 9b, the member 700 may include a body 710, as well as a first engagement portion 720 and/or a second engagement portion 730 connected to the body 710. Although the member 700 includes the first engagement portion 720 and the second engagement portion 730 in the illustrated embodiments, it may include one of the first engagement portion 720 and the second engagement portion 730 depending on the role of the member 700. The body 710 may be disposed peripheral to the first tower portion 120 and the engagement end 220 of the second tower portion 200. The first engagement portion 720 may be engaged to the first tower portion 120 in the longitudinal direction X-X, such as inserted into the first tower portion 120. The second engagement portion 730 may be engaged to the engagement end 220 of the second tower portion 200 in the longitudinal direction X-X, such as inserted into the engagement end 220. The first engagement portion 720 and the second engagement portion 730 may have the same shape or different shapes, which is not limited herein. In the transverse direction Y-Y, the first engagement portion 720 and the second engagement portion 730 may be aligned with each other or staggered. In the vertical direction Z-Z, the first engagement portion 720 and the second engagement portion 730 may be spaced apart from each other. The first engagement portion 720 and the second engagement portion 730 may be inserted into the first tower portion 120 and the engagement end 220 of the second tower portion 200 in the longitudinal direction X-X, i.e., operation in the single direction allows both to be inserted into the first tower portion 120 and the engagement end 220 of the second tower portion 200, respectively, which is easy to operate. Optionally, where outer side surfaces of the second tower portion 200 and the first tower portion 120 perpendicular to the longitudinal direction X-X (i.e., the side surfaces not facing the center of the insulating housing 100) are flush with each other, as shown in FIG. 7a, the body 710 may abut against the outer side surfaces of the second tower portion 200 and the first tower portion 120, which allows for a simpler structure of the body 710. In the transverse direction Y-Y, the first tower portion 120 may be narrower than the second tower portion 200. The body 710 may wrap lower portions of the first side surface 122 and the second side surface 123 of the first tower portion 120, which are not covered by the second tower portion 200, i.e., the body 710 may wrap the first platform 140 and the second platform 150 illustrated in FIGS. 5a and 5b, respectively. As a result, in the transverse direction Y-Y, the space below the second tower portion 200 and on two sides of the first tower portion 120 may be occupied by the body 710. Exemplarily, as shown in FIG. 10, the outer side surfaces of the member 700 opposite each other in the transverse direction Y-Y are flush with the outer side surfaces of the body 110 and the second tower portion 200. As a result, the mounting space occupied by the electrical connector 10 on the printed circuit board 40 can be reduced while ensuring mechanical strength of the member 700 and the first tower portion 120.

Exemplarily, referring to FIGS. 8a, 8b, 9a, and 9b in conjunction, the first engagement portion 720 may include a first insert 721 and a second insert 722. The first insert 721 and the second insert 722 may be spaced apart in the transverse direction Y-Y. The first insert 721 and the second insert 722 may be perpendicular to the vertical direction Z-Z or may have a non-90-degree angle with the vertical direction Z-Z. The heights of the first insert 721 and the second insert 722 in the vertical direction Z-Z may be the same or different, which is not limited herein. Optionally, to facilitate processing, the first insert 721 and the second insert 722 may have the same structure and be disposed at the same vertical height. As shown in FIG. 5a, the first side surface 122 of the first tower portion 120 may comprise a first slit 161. The first slit 161 may extend in the longitudinal direction X-X. The first slit 161 may penetrate to the third side surface 124 so that the first insert 721 may be inserted from the side where the third side surface 124 is disposed into the first slit 161 in the longitudinal direction X-X. Optionally, the first slit 161 may penetrate to the fourth side surface 125, whereby the first insert 721 may have a sufficiently large longitudinal length to ensure its mechanical strength and the reliability of its connection to the first tower portion 120. As shown in FIG. 5b, the second side surface 123 of the first tower portion 120 may comprise a second slit 162. The second slit 162 may extend in the longitudinal direction X-X. The second slit 162 may penetrate to the third side surface 124 so that the second insert 722 may be inserted from the side where the third side surface 124 is disposed into the second slit 162 in the longitudinal direction X-X. Optionally, the second slit 162 may penetrate to the fourth side surface 125, whereby the second insert 722 may have a sufficiently large longitudinal length to ensure its mechanical strength and reliability of its connection to the first tower portion 120. The first insert 721 and the second insert 722 are engaged to the first tower portion 120 on both sides, respectively, making the engagement of the first tower portion 120 with the member 700 more stable. Furthermore, the first insert 721 and the second insert 722 may also contribute to improving the impact resistance performance of the first tower portion 120 in the transverse direction Y-Y.

Exemplarily, in the case where the first side surface 122 of the first tower portion 120 is provided with the first protrusion 131 and the second side surface 123 of the first tower portion 120 is provided with the second protrusion 132, as shown in FIG. 5a and FIG. 5b, the first side surface 122 may be further provided with the first platform 140, and the second side surface 123 may be further provided with the second platform 150. The first platform 140 and the second platform 150 may be disposed below the second tower portion 200. The first protrusion 131 and the second protrusion 132 are covered by the second tower portion 200. The first platform 140 and the second platform 150 may cause a transverse width of a lower portion of the first tower portion 120 to be greater than a transverse width of an upper portion thereof, thereby increasing the mechanical strength of the first tower portion 120. The first platform 140 may be spaced apart from the first protrusion 131 to form the first slit 161. The second platform 150 may be spaced apart from the second protrusion 132 to form the second slit 162. The first platform 140 and the second platform 150 may have the same structure, or different structures, which is not limited herein. The second tower portion 200 extends in the vertical direction Z-Z to the upper edges of the first slit 161 and the second slit 162, as shown in FIG. 7a, and thus it can also be considered that the first slit 161 and the second slit 162 are jointly defined by the first tower portion 120 and the second tower portion 200. The first platform 140 and the second platform 150 may be disposed outside the second tower portion 200. After the first insert 721 is inserted into the first slit 161 between the first platform 140 and the first protrusion 131, the first insert 721 is disposed between the first protrusion 131 and the first platform 140 in the vertical direction Z-Z, such that the first platform 140 and the first protrusion 131 may prevent the first insert 721 from moving in the vertical direction Z-Z. Similarly, the second platform 150 and the second protrusion 132 may prevent the second insert 722 from moving in the vertical direction Z-Z. Upon the engagement of the second tower portion 200 with the first tower portion 120, besides the first protrusion 131 and the second protrusion 132, the second tower portion 200 may also serve to position the member 700. In this way, even if a certain component has a large machining tolerance, a tight connection between the member 700 and the first tower portion 120 can be ensured.

Exemplarily, as shown in FIGS. 5a, 5c, 7a and 8b, the first platform 140 may include two first sub-platforms 140a and 140b spaced apart in the longitudinal direction X-X. As shown in FIG. 5c, a first spacing between the two first sub-platforms 140a and 140b may be aligned with the first protrusion 131. A width T1 of the first spacing may be greater than or equal to a longitudinal dimension T2 of the first protrusion 131. With this configuration, it may be convenient to prepare moulds for injection molding of the first tower portion 120 to form the first protrusion 131. Similarly, as shown in FIG. 5b, the second platform 150 may include two second sub-platforms 150a and 150b spaced in the longitudinal direction X-X. A second spacing between the two second sub-platforms 150a and 150b may be aligned with the second protrusion 132. A width of the second spacing may be greater than or equal to a longitudinal dimension of the second protrusion 132. With this configuration, it may be convenient to prepare moulds for injection molding of the first tower portion 120 to form the second protrusion 132.

Exemplarily, as shown in FIGS. 9a and 9b, the body 710 may include an end sheet 711, a first side sheet 712 and a second side sheet 713. The end sheet 711, the first side sheet 712 and the second side sheet 713 may be connected by soldering, gluing, and the like, or be made by integrated molding. The first side sheet 712 and the second side sheet 713 may extend in the longitudinal direction X-X from opposite sides of the end sheet 711 in the transverse direction Y-Y, respectively. Viewed in the vertical direction Z-Z, the body 710 may be substantially U-shaped. The first tower portion 120 may be clamped between the first side sheet 712 and the second side sheet 713, as shown in FIG. 8a. The body 710 may wrap the first tower portion 120 from the three sides, thereby serving to reinforce the first tower portion 120. Exemplarily, the first engagement portion 720 may be disposed on the first side sheet 712 and/or the second side sheet 713. In the case where the first engagement portion 720 includes the first insert 721 and the second insert 722, the first insert 721 and the second insert 722 may be disposed on the first side sheet 712 and the second side sheet 713, respectively. The first insert 721 and the second insert 722 may be curved toward each other from upper edges of the first side sheet 712 and the second side sheet 713, respectively. The second engagement portion 730 may be disposed on the end sheet 711. A vertical height of the end sheet 711 may be greater than a vertical height of the first side sheet 712 and that of the second side sheet 713. The second engagement portion 730 may be spaced apart from the first side sheet 712 and the second side sheet 713 in the vertical direction Z-Z. The body 710 may serve as a carrier for the first insert 721, the second insert 722 and the second engagement portion 730. Optionally, the member 700 may be a sheet metal member.

Exemplarily, the first side sheet 712 may wrap a portion of the first side surface 122 of the first tower portion 120 between the first slit 161 and the mounting face 102 (that is, a portion exposed by the second tower portion 200) as shown in FIG. 10. With this configuration, the first side sheet 712 and the second tower portion 200 completely cover the first side surface 122 together, thereby providing good reinforcement of the mechanical strength of the first tower portion 120. Exemplarily, the second side sheet 713 may wrap a portion of the second side surface 123 of the first tower portion 120 between the second slit 162 and the mounting face 102 (that is, a portion exposed by the second tower portion 200). With this configuration, the second side sheet 713 and the second tower portion 200 completely cover the second side surface 123 together, thereby providing good reinforcement of the mechanical strength of the first tower portion 120.

Exemplarily, as shown in FIGS. 9a and 9b, the second engagement portion 730 may include a first tab 731 and a second tab 732 spaced apart in the transverse direction Y-Y. The first tab 731 and the second tab 732 may have the same structure, or different structures. The first tab 731 and the second tab 732 may extend from the body 710 substantially in the longitudinal direction X-X. The first tab 731 and the second tab 732 may be disposed at the same height in the vertical direction Z-Z, or at different heights. As shown in FIGS. 6a and 6b, the second tower portion 200 may have an outer side surface 230 perpendicular to the longitudinal direction X-X. A first opening 231 and a second opening 232 may be provided in the outer side surface 230 at the engagement end 220. The first tab 731 and the second tab 732 may be inserted into the first opening 231 and the second opening 232, respectively, in the longitudinal direction X-X. The first tab 731 and the second tab 732 may be disposed on two sides of the first tower portion 120 opposed in the transverse direction Y-Y, respectively. In the foregoing embodiments, the first groove 221a and the second groove 221b for engagement with the first protrusion 131 and the second protrusion 132 of the first tower portion 120, respectively, may be disposed in the opening sidewalls 240a and 240b of the opening 240 opposite each other in the transverse direction Y-Y, whereby the opening sidewalls 240a and 240b have a sufficiently large transverse width to arrange the first opening 231 and the second opening 232, respectively. In the longitudinal direction X-X, the first opening 231 is spaced apart from the first groove 221a, and the second opening 232 is spaced apart from the second groove 221b. The opening sidewalls 240a and 240b may be spaced apart in the transverse direction Y-Y to form the opening 240 passing through the second tower portion 200 in the longitudinal direction X-X. The first tab 731 and the second tab 732 may be disposed on two sides of the first tower portion 120 opposed in the transverse direction Y-Y, whereby the first tab 731 and the second tab 732 may serve to reinforce the first tower portion 120 on both sides of the first tower portion 120. In addition, compared to other portions of the second tower portion 200, the opening sidewalls 240a and 240b have a smaller transverse dimension, and the first tab 731 and the second tab 732 inserted into the opening sidewalls 240a and 240b, respectively, also serve to reinforce the opening sidewalls 240a and 240b.

Exemplarily, the first tab 731 may be engaged to the first opening 231 by interference fit. The interference fit may make the connection between the first tab 731 and the first opening 231 more stable. Exemplarily, the second tab 732 may be engaged to the second opening 232 by interference fit. The interference fit may make the connection between the first tab 731 and the first opening 231 more stable. Optionally, two longitudinal ends of the insulating housing 100 are engaged with second tower portions 200 and members 700. The pair of members 700 may be disposed opposite each other so as to embrace the insulating housing 100 therebetween. In the longitudinal direction X-X, the connection between the second tower portion 200 and the first tower portion 120 mainly relies on the protrusion 130 and the groove 221, and the first tower portion 120 is prone to wear and tear after long-term use, which in turn may lead to loosening of the second tower portion 200 and the first tower portion 120 in the longitudinal direction X-X. The interference fit between the first tab 731 and the first opening 231, and/or the interference fit between the second tab 732 and the second opening 232, may enable the member 700 to be connected to the second tower portion 200 in all directions including the longitudinal direction X-X, which in turn may compensate wear and tear of the first tower portion 120 after long-term use.

Exemplarily, as shown in FIGS. 9a, 9b and 10, the member 700 may further include a circuit board connection portion 740. The circuit board connection portion 740 may be configured for mechanical connection to the printed circuit board 40 (as shown in FIGS. 1-3). Optionally, the circuit board connection portion 740 may comprise one or more feet, for example, four feet. As shown in FIG. 9b and FIG. 10, a first foot 741 and a second foot 742 may be disposed on the first side sheet 712, and a third foot 743 and a fourth foot 744 may be disposed on the second side sheet 713. The printed circuit board 40 may be provided with holes 42 in one-to-one correspondence with the feet. The feet may be inserted into the corresponding holes 42 of the printed circuit board 40. The feet may then be firmly fixed to the printed circuit board 40 by soldering process. Optionally, the circuit board connection portion 740 may also have other structures, for example, the circuit board connection portion 740 may be inserted into the corresponding holes 42 by interference fit, which is not limited herein. The circuit board connection portion 740 and the first engagement portion 720 may be disposed opposite each other on two ends of the first side sheet 712 and the second side sheet 713 in the vertical direction Z-Z. In the case where the first engagement portion 720 includes the first insert 721 and the second insert 722, the first platform 140 and the second platform 150 may be clamped between the first insert 721 and the printed circuit board 40 and between the second insert 722 and the printed circuit board 40, respectively. Optionally, the circuit board connection portion 740 may also be connected to the end sheet 711.

In some embodiments, as shown in FIGS. 3 and 10, the electrical connector 10 may comprise a board lock 50. One end of the board lock 50 may be connected to the printed circuit board 40, such as inserted into a board lock hole 43 in the printed circuit board 40. The other end of the board lock 50 may be connected to the first tower portion 120, such as inserted into a board lock receiver 170 (shown in FIG. 11b and FIG. 10) in the first tower portion 120. The board lock 50 may also be soldered to the printed circuit board 40. The board lock 50 and the circuit board connection portion 740 may be perpendicular to each other, for example, the circuit board connection portion 740 extends in the longitudinal direction X-X, while the board lock 50 extends in the transverse direction Y-Y, which improves the firmness of the connection between the electrical connector 10 and the printed circuit board 40.

According to some embodiments of the present disclosure, a novel latch is provided. The electrical connector 10 in the embodiments of the present disclosure may have a tower, which may include the first tower portion 120 and the second tower portion 200 configured to provide a sufficient space for the novel latch. Referring to FIGS. 3, 11a, 11b and 14, the latch may comprise a first member 400 of the latch and a second member 500 of the latch. The second member 500 of the latch has a first end 510 and a second end 520 opposite each other. The first member 400 of the latch may be pivotally connected to the first end 510 of the second member 500 of the latch between the locked position and the unlocked position. The second end 520 of the second member 500 of the latch may be bent toward the inside of the slot 103. The second member 500 of the latch may be movably disposed in the tower in the vertical direction Z-Z. The first member 400 of the latch may be configured to enable the second member 500 of the latch to be moved in the vertical direction Z-Z when changing between the locked position and the unlocked position. The second end 520 of the second member 500 of the latch may be below the slot 103 when the latch in the locked position, as shown in FIG. 11a. The second end 520 of the second member 500 of the latch may be inside the slot 103 when the latch in the unlocked position, as shown in FIG. 11b.

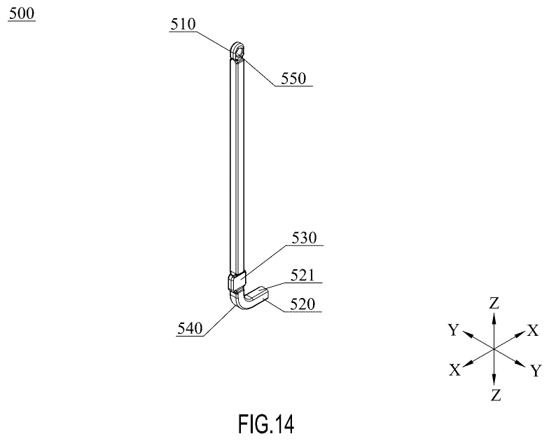

Exemplarily, as shown in FIGS. 11a, 11b and 13, the first member 400 of the latch may have a first surface 401 and a second surface 402. When the latch is in the locked position, the first surface 401 may abut against the latch end 210 of the second tower portion 200. When the latch is in the unlocked position, the second surface 402 may abut against the latch end 210 of the second tower portion 200. In the illustrated embodiment, both the first surface 401 and the second surface 402 are planes. However, Optionally, the first surface 401 and the second surface 402 may also be curved as long as they are able to abut against the latch end 210 and remain in position when not subjected to an external force. As shown in FIGS. 6a, 11a and 11b, a channel 201 extending in the vertical direction Z-Z may be provided inside the second tower portion 200. The channel 201 may have the same cross-section or different cross-sections at different heights. The cross-section of the channel 201 may be rectangular, circular, or other shapes. The second member 500 of the latch may extend through the channel 201. The first member 400 of the latch may be pivotably connected to the first end 510 of the second member 500 of the latch about the first end 510 end of the second member 500 (e.g., about a pivot axis P). Optionally, the first member 400 of the latch may have a first hole 404, as shown in FIG. 13. The first end 510 of the second member 500 of the latch may have a second hole 550, as shown in FIG. 14. A pin 430 may pass through the first hole 404 and the second hole 550, thereby allowing the first member 400 of the latch to be pivotably connected to the first end 510 of the second member 500 of the latch about the pivot axis P at the first end 510 of the second member of the latch, which may be defined by the pin 430. Optionally, the first member 400 of the latch may also be pivotably connected to the first end 510 of the second member 500 of the latch in other ways.

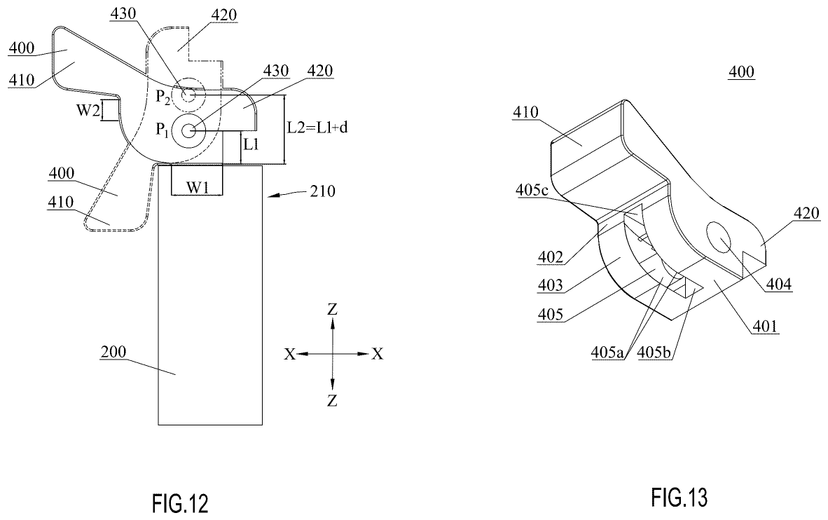

As shown in FIGS. 11b and 12, a first distance L1 from the pivot axis P to the first surface 401 may be less than a second distance L2 from the pivot axis P to the second surface 402. The difference L2−L1 may be denoted as d, i.e., L2=L1+d. That is, the distance L1 from the pivot axis P to the upper end surface of the second tower portion 200 when the latch is in the locked position is less than the distance L2 from the pivot axis to the upper end surface of the second tower portion 200 when the latch is in the unlocked position. As shown in FIG. 12, the pivot axis is disposed at a position P1 when the first member 400 of the latch is in the locked position (shown as a solid line), and the pivot axis is disposed at a position P2 when the first member 400 of the latch is in the unlocked position (shown as a dashed line). The distance from P1 to P2 is d, thus as the first member 400 of the latch is moved between the locked position and the unlocked position, the second member 500 of the latch can be driven to move the distance d in the vertical direction Z-Z. In the illustrated embodiment, the first member 400 of the latch has a cam structure. Optionally, the first member 400 of the latch may also have other structures as long as it is able to drive the second member 500 of the latch to move in the vertical direction Z-Z in the pivoting process. By adjusting the sizes of the first distance L1 and the second distance L2, the moveable distance of the second member 500 of the latch can be changed.

As shown in FIGS. 11a, 11b, 12b and 14, the second member 500 of the latch is substantially L-shaped. An outer side at the bend may have a connection surface 540. The board lock 50 may be disposed below the connection surface 540. The second member 500 of the latch may be made of a material with greater mechanical strength, such as metal. As shown in FIG. 11a, when the first member 400 of the latch is in the locked position, the second end 520 of the second member 500 of the latch may be below the first slot 103. At this time, the second end 520 may not interfere with the electronic card 20. Exemplarily, the second end 520 of the second member 500 of the latch may have a surface 521 facing the mating face 101. As shown in FIG. 11a, when the first member 400 of the latch is in the locked position, the surface 521 may be level with a bottom surface of the first slot 103. When the first member 400 of the latch is in the locked position, the electronic card 20 may be supported by the bottom surface of the first slot 103. The surface 521 being level with the bottom surface of the first slot 103 with the first member 400 of the latch in the locked position may enable the surface 521 to also support the electronic card 20. Due to the greater mechanical strength of the second member 500 of the latch, it can share the force of the electronic card 20 acting on the insulating housing 100, which in turn may provide to the insulating housing 100. The side edge of the electronic card 20 can be firmly clamped between the upper first member 400 of the latch and the lower second end 520, thereby ensuring the firmness of the locked electronic card 20. And it can also make the structure of the electrical connector 10 more compact. Optionally, the surface 521 may be disposed at any position below the bottom surface of the first slot 103 when the first member 400 of the latch is in the locked position, as long as the second end 520 of the second member 500 of the latch does not protrude beyond the mounting face 102 of the insulating housing 100.

As shown in FIG. 11b, when the first member 400 of the latch is in the unlocked position, the second end 520 of the second member 500 of the latch moves upwardly into the first slot 103. When the electronic card 20 needs to be mounted, the electronic card 20 may be inserted downwardly into the first slot 103, and under this downward insertion force, a lower end of the electronic card 20 can press the second end 520 of the second member 500 of the latch within the first slot 103, which in turn induces the second member 500 of the latch to have a tendency to move downwardly, forcing the first member 400 of the latch to pivot about its pivot axis P to the locked position. Until the electronic card 20 is inserted in place into the first slot 103, the second end 520 of the second member 500 of the latch is pushed to the underneath of the first slot 103. At this time, the first member 400 of the latch is pivoted to the first surface 401 to abut against the latch end 210 of the second tower portion 200, and the first member 400 of the latch can be retained in the locked position.

When removing the electronic card 20, a user may pivot the first member 400 of the latch such that the first member 400 of the latch is pivoted about the pivot axis P. In the process of pivoting, the first member 400 of the latch is gradually pivoted from the first surface 401 against the latch end 210 of the second tower portion 200 to the second surface 402 against the latch end 210 of the second tower portion 200. Since the distance L1 of the pivot axis P to the first surface 401 is smaller than the distance L2 to the second surface 402, the distance between the latch end 210 and the pivot axis changes during the unlocking process, and the distance from the pivot axis to the latch end 210 increases from L1 to L2, that is the pivot axis rises by the distance d from the position P1 to the position P2, as shown in FIG. 12. As a result, the second member 500 of the latch is also moved upwardly along with the pivot axis by the distance d. Thus, the second member 500 of the latch can lift the electronic card 20 upwardly by the distance d. At this time, the user can conveniently take out the electronic card 20 after the upward movement.

For the purpose that the first member 400 of the latch can be pivoted to the locked position by the insertion force of the electronic card 20, exemplarily, the first member 400 of the latch may be configured to remain less stable in the unlocked position than in the locked position. The first member 400 of the latch may be in the unlocked position for a shorter period of time and is in a non-operational position. As shown in FIG. 12, when the first member 400 of the latch is in the locked position, the first surface 401 may have a first dimension W1 in the longitudinal direction X-X. When the first member 400 of the latch is in the unlocked position, the second surface 402 may have a second dimension W2 in the longitudinal direction X-X. The first dimension W1 may be larger than the second dimension W2. The first member 400 of the latch may need to be pivoted by a very small angle from the unlocked position to a position where the second surface 402 no longer abuts against the upper end surface of the second tower portion 200. In this way, the downward insertion force exerted by the user on the electronic card 20 causes the first member 400 of the latch to pivot toward the locked position. Moreover, when the first member 400 of the latch is in the locked position, the first member 400 of the latch has a large contact area with the upper end surface of the second tower portion 200, and the first member 400 of the latch can be more reliably held in the locked position, and the user's operation on the first member 400 of the latch may be needed in order to unlock it.

As previously mentioned, the second tower portion 200 is provided with a second slot 202, as shown in FIGS. 3 and 6a. Exemplarily, the first dimension W1 of the first surface 401 (as shown in FIG. 11a) may be greater than or equal to half of a distance W3 (as shown in FIG. 6a) from the second slot 202 to the outer side surface 230 of the second tower portion 200 perpendicular to the longitudinal direction X-X. As a result, in the longitudinal direction X-X, the first surface 401 may abut against a majority of the top surface of the second tower portion 200 when the first member 400 of the latch is in the locked position, thereby ensuring the stability of the first member 400 of the latch in the locked position. In the longitudinal direction X-X, the first surface 401 may not extend into the second slot 202 to avoid interference with the electronic card 20. Optionally, the first surface 401 may extend to a bottom surface of the second slot 202 perpendicular to the longitudinal direction X-X.

Exemplarily, as shown in FIGS. 11a, 11b and 13, the first surface 401 and the second surface 402 may be connected to each other by a transition surface 403. This configuration allows for a smooth transition from the first surface 401 to the second surface 402, and the first member 400 of the latch can be smoothly pivoted to the locked position after it leaves the unlocked position. Exemplarily, the first surface 401 and the second surface 402 may be perpendicular to each other. With this configuration, the locked position and the unlocked position of the latch can be switched by rotating the first member 400 of the latch by 90 degrees, and the effective travel of pivoting is shorter, which shortens the time for switching.

Exemplarily, as shown in FIGS. 11a, 11b and 13, a cavity 405 may be provided in the first member 400 of the latch. The cavity 405 may extend from the first surface 401 through the transition surface 403 to the second surface 402. The first end 510 of the second member 500 of the latch may extend into the cavity 405. The cavity 405 may have a pair of first cavity sidewalls 405a spaced apart in transverse direction Y-Y, and a second cavity sidewall 405b and a third cavity sidewall 405c connected between the pair of first cavity sidewalls 405a, as shown in FIG. 13. In the illustrated embodiment, the second cavity sidewall 405b and the third cavity sidewall 405c may be perpendicular to each other. When the first member 400 of the latch is in the locked position, the first end 510 of the second member 500 of the latch may abut against the second cavity sidewall 405b of the cavity 405, as shown in FIG. 11a. With this configuration, the first end 510 of the second member 500 of the latch may be hidden in the cavity 405, making the structure more compact. Moreover, the second cavity sidewall 405b may serve to position the first end 510 of the second member 500 of the latch, so that the first member 400 of the latch can be retained in the locked position after pivoted to the locked position, avoiding excessive pivoting of the first member 400 of the latch under the action of an external force for inserting the electronic card 20.

Exemplarily, as shown in FIGS. 11a and 11b, the electrical connector 10 may comprise a resilient member 600. The resilient member 600 may be formed from a resilient material, such as rubber or spring, and the like. The resilient member 600 may connect the second member 500 of the latch and the first tower portion 120, or between the second member 500 of the latch and the second tower portion 200. With the first member 400 of the latch in the locked position, the resilient member 600 may have a first deformation amount. With the first member 400 of the latch in the unlocked position, the resilient member 600 may have a second deformation amount. The second deformation amount is greater than the first deformation amount. The first deformation amount may be zero or any value greater than zero. The first deformation amount and the second deformation amount may be a stretching amount or a compression amount. When the first member 400 of the latch is in the unlocked position, the resilient member 600 may store more elastic potential energy. The resilient member 600 may continuously accumulate the elastic potential energy as the user pivots the first member 400 of the latch to the unlocked position. When inserting the electronic card 20 into the electrical connector 10, in addition to the insertion force exerted by the user on the electronic card 20, the resilient member 600 may be able to exert a downward force on the second member 500 of the latch, so that the user can insert the electronic card 20 with less effort. In addition, it is also possible to retain the first member 400 of the latch in the locked position in a stable manner. Moreover, when the electrical connector 10 is not in use, the resilient member 600 can also keep the second member 500 of the latch and the first member 400 of the latch in the current position, so as to prevent them from moving around randomly.

Exemplarily, as shown in FIGS. 11a, 11b and 14, a flange 530 may be provided on the middle portion of the second member 500 of the latch. The resilient member 600 may be sleeved on the second member 500 of the latch and clamped between the flange 530 and the second tower portion 200. Manufacturing the second tower portion 200 and the insulating housing 100 as separate individual members independent from each other may facilitate the mounting of the resilient member 600. In this embodiment, the resilient member 600 may be in a natural state or a state with lesser amount of compression when the first member 400 of the latch is in the locked position. When the first member 400 of the latch is in the unlocked position, the resilient member 600 may be further compressed. Optionally, Optionally, the resilient member 600 may further be disposed between the flange 530 and the first tower portion 120, for example below the flange 530. In some embodiments, the resilient member 600 may be in a natural state or a state with lesser amount of stretch when the first member 400 of the latch is in the locked position. When the first member 400 of the latch is in the unlocked position, the resilient member 600 may be further stretched.

Exemplarily, the aperture 180 may be provided inside the first tower portion 120 as shown in FIGS. 5a, 5b, 7b, 11a and 11b. The resilient member 600 may be disposed inside the aperture 180. The aperture 180 may be recessed downwardly from an upper end of the first tower portion 120. Considering the space on the first tower portion 120 is relatively limited, in the transverse direction X-X, the aperture 180 and the first slot 103 may be connected with each other. This may be more convenient for preparing moulds and facilitate the mounting of the second end 520 of the second member 500 of the latch. The aperture 180 may be aligned with the channel 201 in the second tower portion 200. A cross-sectional area of the aperture 180 perpendicular to the vertical direction Z-Z may be greater than a cross-sectional area of the channel 201 in that direction. The cross-sectional area of the aperture 180 may be adapted to a cross-sectional area of the resilient member 600. The aperture 180 may further be used to accommodate a wider flange 530 of the second member 500 of the latch. An upper end of the resilient member 600 may abut against a lower end surface of the second tower portion 200. Exemplarily, a cross-section of the channel 201 may be adapted to a cross-section of the second member 500 of the latch. The channel 201 may serve to guide the movement of the second member 500 of the latch in the vertical direction Z-Z. In addition, the second member 500 of the latch may be selected to be made of materials with greater strength than those for the second tower portion 200, in which case the second member 500 of the latch may also serve to reinforce the mechanical strength of the second tower portion 200.

It should be appreciated the latch described herein may also be applied to the embodiments in which the insulating housing 100 and the second tower portion 200 are formed into an integrated piece, and the integrated piece including the insulating housing 100 and the second tower portion 200 may be referred to as a connector body. The connector body may be provided with a plurality of conductive elements 300 as well as slots, which may include the first slot 103 and the second slot 202.

According to aspects of the present disclosure, the insulating housing may have a second tower portion connected to a first tower portion, thereby increasing the height of the tower that includes both the first tower portion and the second tower portion. The second tower portion and the insulating housing may be separately processed members. A plurality of conductive elements may be held by the insulating housing to ensure that the plurality of conductive elements are electrically insulated from each other. In some embodiments, the insulating housing may be made of an insulating material and processed by molding process. The second tower portion is not necessary to be insulating and may have a relatively simpler structure. Exemplarily, the second tower portion may be made of a material with greater strength, such as metal, ceramic, and the like. Such a configuration enables the electrical connector to have sufficient mechanical strength for receiving tall cards.

Optionally, it is possible to improve the mechanical strength of the electrical connector by enlarging its dimensions in all directions based on conventional designs. However, the Inventors have recognized and appreciated that such an enlarged electrical connector may lead to unfavorable effects in two aspects. First, such enlarged electrical connectors require a larger footprint on the printed circuit board, the available space on which is becoming more and more limited unfortunately under the trend of miniaturization; and/or require a reduced spacing between adjacent connectors, which is not conducive to heat dissipation. Secondly, such enlarged electrical connectors cannot be able to comply with industry standards such as JEDEC standard, which is obviously not conducive to forward compatibility of tall electronic cards with the existing standard systems.

According to aspects of the present disclosure, first member of the latches may be connected to tops of the second tower portions. As a result, the height of the notches in the side edges of the electronic card can be increased, allowing a large portion of the electrical connector to be locked by the electronic card, thereby ensuring reliable mechanical connection between the electronic card and the electrical connector. Exemplarily, the latches may be locked to the electronic card at, for example, a position greater than ½ height, or even up to ⅔ height of the card.

According to aspects of the present disclosure, the second tower portions and the insulating housing may be manufactured separately as independent members, there may be more options for the materials of the second tower portions. For example, the second tower portions may be formed from a material with greater mechanical strength, unnecessary to be insulating material such as plastic, while the insulating housing may be formed from an insulating material such as plastic. As a result, mechanical strength of the electrical connector can be increased. And it is advantageous to improve overall mechanical strength that the second tower portions each is designed to be as tall as possible or wrap at least partially three surfaces of each of the first tower portions. Further, it is also advantageous to simplify the manufacturing process if the second tower portions and the insulating housing are manufactured separately, as compared to manufacturing them as an integrated piece by injection molding process (in this case the first tower portions and the second tower portions may be collectively referred to as towers). The Inventors have further recognized and appreciated that when the second tower portions and the insulating housing are processed into an integrated piece by injection molding process, binding lines may be formed at the middle portions of the towers after cooling. The middle portions correspond exactly to a slot receiving an edge of an add-in card, and the thickness of the middle portions is relatively small. The binding lines may result in decreases in mechanical strength of the portions which may be more prone to crack at the binding lines under an external force. By manufacturing the second tower portions and the insulating housing separately as independent members and then connecting them together, the positions of the binding lines may be altered to a certain extent, thereby improving overall mechanical strength.

According to aspects of the present disclosure, a latch may include a second member of the latch movable in a height direction and a first member of the latch connected to a first end of the second member of the latch. A second end of the second member of the latch may be bent into the slot, and the locking and unlocking of the latch may drive the second end of the second member of the latch in and out of the slot. When the latch is in the locked position, the second end of the second member of the latch may be disposed outside the slot to avoid affecting the insertion of the electronic card into the slot; and when the latch is in the unlocked position, the second end of the second member of the latch may be moved in the height direction into the slot so as to lift the electronic card upwardly.

According to aspects of the present disclosure, the second member of the latch may penetrate through the second tower portion and into the first tower portion. The second member of the latch may be made of a material with greater mechanical strength, such as metal. As a result, the second member of the latch may be used as an inner core of the second tower portion, structurally reinforcing the second tower portion. The second member of the latch may be made of a material with greater mechanical strength than the second tower portion. For example, it may be made of alloys with greater hardness, such as stainless steel, and the like. In some embodiments, a resilient member may be provided between the second member of the latch and the first tower portion or between the second member of the latch and the second tower portion, and the resilient member may ensure that the position of the second member of the latch is relatively stable no matter whether the latch is in the locked position or the unlocked position, without randomly changing the position in the height direction. Furthermore, the resilient member may be configured to have a greater deformation amount with the latch in the unlocked position and a less deformation amount or no deformation amount with the latch in the locked position. Thus, the insertion force exerted by a user and the resilient force released by the resilient member when the electronic card is inserted into the electrical connector may pivot the latch to the locked position automatically without operating the latch. The user may need to pivot the latch to the unlocked position when the electronic card is expected to be detached from the electrical connector. This makes the electrical connector much easier to use.

According to aspects of the present disclosure, a member may be provided to reinforce one or more from the following connections, such as a connection between the first tower portion and the second tower portion, a connection between the first tower portion and the printed circuit board, and a connection of the three, namely the first tower portion, the second tower portion and the printed circuit board. In some embodiments, the member may at least partially wrap the three surfaces of the first tower portion of the insulating housing, thereby providing structural reinforcement to the first tower portion. In some embodiments, the member may connect the first tower portion and the second tower portion, thereby forming a reliable mechanical connection therebetween. In some embodiments, the member may further be connected to the printed circuit board, thereby forming a reliable mechanical connection between the insulating housing and the printed circuit board and/or between the second tower portion and the printed circuit board.

Having thus described several aspects of embodiments of card edges connectors, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

For example, although many inventive aspects are shown and described with reference to a card edge connector having a vertical configuration, it should be appreciated that aspects of the present disclosure is not limited in this regard, as any of the inventive concepts, whether alone or in combination with one or more other inventive concepts, may be used in other types of electrical connectors, such as backplane connectors, daughter card connectors, cable connectors, stacking connectors, mezzanine connectors, I/O connectors, chip sockets, Gen Z connectors, etc.

As another example, although mounting tails were illustrated as surface mounting elements, other configurations may also be used, such as press fit “eye of the needle” compliant sections that are designed to fit within vias of printed circuit boards, spring contacts, solderable pins, etc., as aspects of the present disclosure are not limited to the use of any particular mechanism for attaching connectors to printed circuit boards.

In the description of the present disclosure, it is to be understood that orientation or positional relationships indicated by orientation words “front’, “rear”, “upper”, “lower”, “left”, “right”, “transverse direction”, “longitudinal direction”, “vertical direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising a body and a first tower portion disposed at an end of the body, the body having a slot, the first tower portion extending beyond a mating face;
a second tower portion comprising a first end engaging the first tower portion of the housing and a second end opposite the first end; and
a latch coupled to the second tower portion and movable between a locked position and an unlocked position.

2. The electrical connector of claim 1, wherein:
the second tower portion is made of a material stronger than the housing.

3. The electrical connection of claim 1, wherein:
the first end of the second tower portion at least partially wraps three surfaces of the first tower portion.

4. The electrical connector of claim 3, wherein:
the first tower portion comprises a protrusion; and
the second tower portion comprise a groove receiving the protrusion of the first tower portion.

5. The electrical connector of claim 1, further comprising:
a member engaging both the first tower portion and the first end of the second tower portion so as to connect the first tower portion with the second tower portion.

6. The electrical connector of claim 5, wherein:
the member comprises a body, a first engagement portion engaging the first tower portion, and a second engagement portion engaging the first end of the second tower portion.

7. The electrical connector of claim 1, wherein the latch comprises:
a first member comprising a first surface butting against the second end of the second tower portion when the latch is in the locked position, and a second surface butting against the second end of the second tower portion when the latch is in the unlocked position.

8. The electrical connector of claim 7, wherein:
the second tower portion comprises a channel extending from the first end to the second end;
the latch comprises a second member disposed in the channel and having a first end coupled to the first member such that the first member is pivotably mounted about an end of the second member; and
a distance from the end of the second member to the first surface of the first member is less than a distance from the end of the second member to the second surface of the first member.

9. The electrical connector of claim 8, wherein:
the second member of the latch comprises a second end opposite the first end and extending toward the slot of the housing.

10. A method of operating an electrical connector comprising a housing body comprising a mating face, a mounting face and a slot extending through the mating face and elongating in a longitudinal direction, a tower extending from an end of the housing body in a vertical direction perpendicular to the longitudinal direction, and a latch coupled to the tower and comprising first and second members, the method comprising:
pivoting the first member of the latch about an end of the second member of the latch so as to move the second member in the vertical direction.

11. The method of claim 10, comprising:
inserting a card into the slot which moves the second member in a direction opposite to the vertical direction.

12. An electrical connector comprising:
a housing comprising a body and a tower extending from an end of the body, the body having a mating face, a mounting face opposite the mating face, and a slot extending from the mating face toward the mounting face;
a plurality of conductive elements held by the housing, each of the plurality of conductive elements comprising a mating portion curving into the slot and a mounting tail opposite the mating portion and extending out of the mounting face; and
a latch coupled to the housing and comprising a first member and a second member, wherein the first member is pivotable about an end of the second member so as to move the second member in a vertical direction when the latch moves between a locked position and an unlocked position.

13. The electrical connector of claim 12, wherein:
the first member of the latch comprises a first surface spaced from the end of the second member by a first distance and a second surface spaced from the end of the second member by a second distance; and
the second member moves by a difference between the second distance and the first distance when the latch switches between the locked position and the unlocked position.

14. The electrical connector of claim 13, wherein:
the first member of the latch comprises a transition surface joining the first surface and the second surface.

15. The electrical connector of claim 14, wherein:
the first surface and the second surface are perpendicular to each other.

16. The electrical connector of claim 13, wherein:
when the latch in the locked position, the first surface of the first member abuts against the tower of the housing; and
when the latch is in the unlocked position, the second surface abuts against the tower of the housing.

17. The electrical connector of claim 12, wherein:
the first member of the latch comprises a cavity;
the end of the second member of the latch extends into the cavity; and
when the latch in the locked position, the second member of the latch abuts against a sidewall of the cavity.

18. The electrical connector of claim 12, further comprising:
a resilient member disposed between the second member of the latch and the tower of the housing, wherein:
the resilient member deforms a first amount when the latch is in the locked position and a second amount greater than the first amount when the latch is in the unlocked position.

19. The electrical connector of claim 12, wherein:
the tower of the housing comprises a first tower power extending from the body of the housing and a second tower portion coupled to the first tower power;
the first member of the latch is disposed on the second tower portion; and
the second member of the latch extends in the second tower portion.

20. The electrical connector of claim 12, wherein:
the slot of the body of the housing elongates in a longitudinal direction; and
the tower extends above a notch of a standard DDR card in a vertical direction perpendicular to the longitudinal direction.
